(19) United States
(12) Patent Application Publication
(10) Pub. No.: US 2003/0065600 A1
(43) Pub. Date: Apr. 3, 2003

(54) Method and program for supporting securities selection

(76) Inventors: Shigehiko Terashima, Shinjuku (JP); Kimiko Terashima, Shinjuku (JP); Kokei Suzuki, Kawasaki (JP); Yoshinobu Sawano, Kawasaki (JP)

Correspondence Address: STAAS & HALSEY LLP, 700 11TH STREET, NW, SUITE 500, WASHINGTON, DC, 20001, US

(21) Appl. No.: 10/106,287

(22) Filed: Mar. 27, 2002

(30) Foreign Application Priority Data
Sep. 28, 2001 (JP) 2001-300066

(51) Int. Cl. G06F 17/60

(52) U.S. Cl. 705/36

(57) ABSTRACT

A securities selection support method and securities selection support program that can clearly indicate the characteristics of a risk on an investment in a financial instrument selected optionally. A computer selects proposed investment securities to be invested in from among a plurality of securities. Then the computer calculates investment risk standard values according to a plurality of risk indexes on the basis of investment risk information in which an investment risk regarding the plurality of risk indexes is set for each of the plurality of securities. And then the computer calculates deviations according to the plurality of risk indexes by comparing the investment risk standard values according to the plurality of risk indexes and a risk on an investment in the proposed investment securities (or a compound investment risk calculated from risks on investments in a plurality of proposed investment securities). Finally the computer outputs messages indicative of the characteristics of the risk on the investment in the proposed investment securities in accordance with the calculated deviations according to the plurality of risk indexes.

### BACKGROUND OF THE INVENTION

(1) Field of the Invention

This invention relates to a securities selection support method for supporting the selection of securities to be invested in with a computer and securities selection support program for making a computer perform this function and, more particularly, to a securities selection support method for supporting the selection of a combination of a plurality of securities to be invested in and securities selection support program for making a computer perform this function.

(2) Description of the Related Art

With an increase in the aged population in the society in the future, the public pension system, including the welfare pensions and national pensions, will reach a stalemate. In recent years this has been considered to be problematic. Moreover, due to chronically low interest rates people cannot expect highly safe bank deposits to increase their assets. Therefore, an increasing number of people intend to increase their assets actively by managing their financial assets by, for example, investment trusts suitable for long-term management.

Usually these financial assets are managed via securities companies etc. Securities companies etc. listen to each investor's various investment needs, such as an expected return and fund, take into consideration the investment climate where various factors are entangled complexly, combine domestic or foreign securities, such as stocks and public and corporate bonds, and suggest a method for managing his/her financial assets most suitable to his/her investment needs.

Advanced expertise in the stock market, economics, and the like is essential for listening to an investor's various investment needs and suggesting a method for managing his/her financial assets suitable for his/her investment needs.

Diversified investments should be made in a plurality of securities especially for diminishing risk and increasing a rate of returns. This is called portfolio management. To perform appropriate portfolio management, the financial market must be analyzed calmly through research and financial instruments to be invested in must be selected with the characteristics of each financial instrument taken into consideration.

However, it is difficult for a person who is not a specialist, such as a security analyst, to analyze the financial market calmly and to analyze an investment risk in the case of combining a plurality of financial instruments. Therefore, it is desirable that a person without advanced expertise can accurately judge an investment risk in the case of combining a plurality of financial instruments entails.

### SUMMARY OF THE INVENTION

The present invention was made under the background circumstances as described above. An object of the present invention therefore is to provide a securities selection support method and securities selection support program that can clearly indicate the characteristics of a risk on an investment in a financial instrument selected optionally.

In order to achieve the above object, a securities selection support method for supporting the selection of a target for investment by the use of a computer is provided. This securities selection support method comprises the steps of selecting proposed investment securities to be invested in from among a plurality of securities, calculating investment risk standard values according to a plurality of risk indexes on the basis of investment risk information in which an investment risk regarding the plurality of risk indexes is set for each of the plurality of securities, calculating deviations according to the plurality of risk indexes by comparing the investment risk standard values according to the plurality of risk indexes and a risk on an investment in the proposed investment securities set in the investment risk information, and outputting messages indicative of characteristics of the risk on the investment in the proposed investment securities in accordance with the calculated deviations according to the plurality of risk indexes.

Moreover, in order to achieve the above object, a securities selection support method for supporting the selection of a target for investment by the use of a computer is provided. This securities selection support method comprises the steps of selecting a combination of a plurality of proposed investment securities to be invested in from among a plurality of securities, calculating investment risk standard values according to a plurality of risk indexes on the basis of investment risk information in which an investment risk regarding the plurality of risk indexes is set for each of the plurality of securities, calculating compound investment risks according to the plurality of risk indexes in the case of investing in a combination of the selected proposed investment securities on the basis of the investment risk information, calculating deviations according to the plurality of risk indexes by comparing the investment risk standard values and the compound investment risks according to the plurality of risk indexes, and outputting messages indicative of the characteristics of the compound investment risks in accordance with the calculated deviations according to the plurality of risk indexes.

In addition, in order to achieve the above object, a securities selection support method for supporting the selection of a target for investment by the use of a computer is provided. This securities selection support method comprises the steps of selecting a base issue group from among a plurality of issue groups each of which has been set as a set of pieces of identification information for a plurality of securities, selecting proposed investment securities to be invested in from among the plurality of securities, obtaining investment risks on securities corresponding to the pieces of identification information included in the base issue group selected from investment risk information in which investment risks regarding a plurality of risk indexes are set for each of the plurality of securities and calculating investment risk standard values according to the plurality of risk indexes on the basis of the investment risks, calculating deviations according to the plurality of risk indexes by comparing, according to the plurality of risk indexes, the investment risk standard values and an investment risk on the proposed investment securities set in the investment risk information, and outputting messages indicative of characteristics of the investment risk on the proposed investment securities in accordance with the calculated deviations according to the plurality of risk indexes.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view showing a securities selection support method according to the present invention.

FIG. 2 is a block diagram showing the hardware structure of a securities selection support unit.

FIG. 3 is a block diagram showing the functions of a securities selection support unit according to a first embodiment.

FIG. 4 is a view showing an example of investment risk information stored in an investment risk information storing section.

FIG. 5 is a view showing an example of issue groups stored in an issue group storing section.

FIG. 6 is a view showing an example of characteristic indication messages stored in a characteristic indication message storing section.

FIG. 7 is a flow chart showing a procedure for all the process of supporting the selection of securities.

FIG. 8 is a flow chart showing a procedure for the process of generating a message.

FIG. 9 is a view showing an example of a display screen indicating the characteristics of an investment risk.

FIG. 10 is a view showing an example of a display screen which appears after proposed investment securities being changed.

FIG. 11 is a view showing an example of a display screen which appears after a base issue group being changed.

FIG. 12 is a view showing an example of a display screen which appears when a standard for axes on a radar chart is changed with a change of base issue group.

FIG. 13 is a schematic view showing the structure of an asset management invitation unit.

FIG. 14 is a block diagram showing the functions of an asset management invitation unit according to a second embodiment.

FIG. 15 is a schematic view showing the data structure of securities attribute information stored in the securities information storing section shown in FIG. 14.

FIG. 16 is a schematic view showing the data structure of fund information stored in the investment trust database shown in FIG. 15.

FIG. 17 is a schematic view showing the data structure of stock information stored in the stock database shown in FIG. 15.

FIG. 18 is a schematic view showing the structure of held financial assets information stored in the held financial assets structure information storing section shown in FIG. 14.

FIG. 19 is a schematic view showing the data structure of the held financial assets information shown in FIG. 18.

FIG. 20 is a view showing the data structure of recommendation message information stored in the recommendation message information storing section shown in FIG. 14.

FIG. 21 is a schematic view showing the data structure of investment needs fulfillment financial assets information stored in the investment needs fulfillment financial assets information storing section shown in FIG. 14.

FIG. 22 is a schematic view showing the data structure of the investment needs fulfillment financial assets information shown in FIG. 21.

FIG. 23 is a flow chart for describing all the process performed by the asset management invitation unit according to the second embodiment.

FIG. 24 is a flow chart for describing the details of the process performed in step S1 in the flow chart shown in FIG. 23.

FIG. 25 is a flow chart for describing the details of the process performed in step S3 in the flow chart shown in FIG. 23.

FIG. 26 is a view showing the structure of a questionnaire display screen which appears in the case of inputting investor information.

FIG. 27 is a view showing the structure of a questionnaire result display screen which indicates the results of a questionnaire.

FIG. 28 is a view showing the structure of a schooling screen.

FIG. 29 is a view showing the structure of a result display screen on which the contents of specified securities are displayed in the form of a list.

FIG. 30 is a view showing a target setting screen 140 which appears in the case of inputting investment needs.

FIG. 31 is a flow chart for describing the details of the process performed in step S6 in the flow chart shown in FIG. 23.

FIG. 32 is a flow chart for describing a concrete example of the process performed in step S6 in the flow chart shown in FIG. 23.

FIG. 33 is a flow chart for describing a concrete example of the process performed in step S6 in the flow chart shown in FIG. 23.

FIGS. 34(A) and 34(B) are views showing a portfolio in which the expected values of financial assets held by an investor are indicated with a radar chart, FIG. 34(A) being a view showing a portfolio in which the expected values at the beginning of a period of held financial assets are indicated with a radar chart, and FIG. 34(B) being a view showing a portfolio in which the expected values at some point in the period (present valuation values) of the held financial assets are indicated with a radar chart.

FIGS. 35(A) and 35(B) are views each showing a portfolio of investment needs fulfillment financial assets selected as financial assets which fulfill investment needs and indicated in information stored in the investment needs fulfillment financial assets information storing section.

FIGS. 36 is a view showing a portfolio of investment needs fulfillment financial assets selected as financial assets which fulfill investment needs and indicated in information stored in the investment needs fulfillment financial assets information storing section.

FIG. 37 is a flow chart for describing the details of the process performed in step S8 in the flow chart shown in FIG. 23.

FIG. 38 is a view showing a rebalancing result display screen.

### DESCRIPTION OF THE PREFERRED EMBODIMENTS

Embodiments of the present invention will now be described with reference to the drawings.

First the basic concept of a securities selection support method for supporting the selection of securities to purchase will be described, then embodiments will be described in detail.

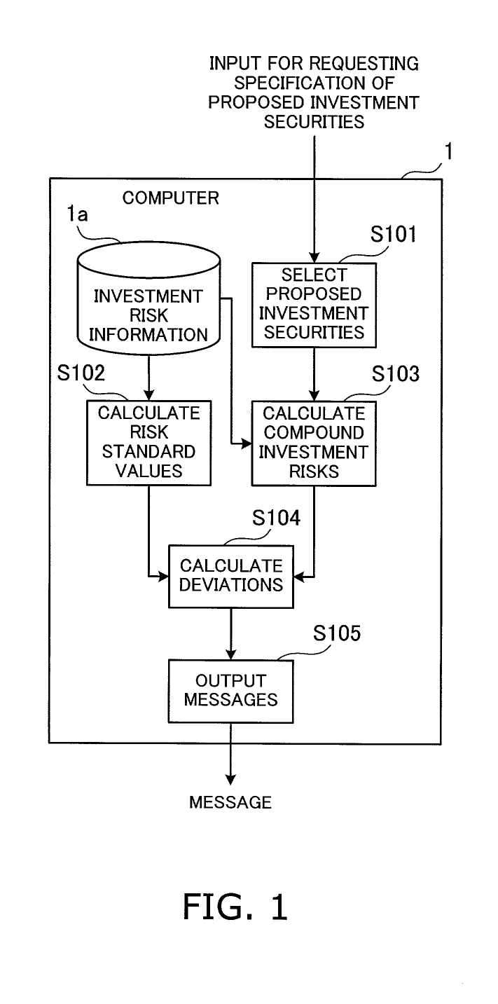

FIG. 1 is a schematic view showing a securities selection support method according to the present invention. With a securities selection support method according to the present invention, a computer 1 will perform the following process. Investment risk information 1a is stored in advance in the computer 1. The investment risk information 1a is information regarding a plurality of risk indexes set in advance for each of a plurality of securities.

First, the computer 1 selects at least one proposed investment securities from among a plurality of securities in response to input to the computer 1 for requesting the specification of proposed investment securities (step S101). For example, a user operates to provide this input for requesting the specification of proposed investment securities.

Then the computer 1 calculates investment risk standard values according to risk indexes on the basis of the investment risk information 1a (step S102). For example, averages according to the risk indexes for registered securities are considered as investment risk standard values. Investment risk standard values may also be calculated by the use of a predetermined expression in which the total market value of the proposed investment securities is taken into consideration.

On the basis of the investment risk information 1a, the computer 1 calculates compound investment risks according to the risk indexes in the case of investing in a combination of the proposed investment securities selected in step S101 (step S103). For example, averages according to the risk indexes for the proposed investment securities are considered as compound investment risks. Compound investment risks may also be calculated by the use of a predetermined expression in which the volume (or amount) of an investment in the proposed investment securities is taken into consideration.

If the number of the proposed investment securities is only one, the values of the risk indexes for the proposed investment securities, for example, and the investment risk standard values are compared. That is to say, if the number of the proposed investment securities is only one, the process of calculating compound investment risks can be skipped.

The computer 1 compares the investment risk standard values according to the risk indexes and the compound investment risks and calculates deviations according to the risk indexes (step S104). If the number of the proposed investment securities is one, the investment risk standard values according to the risk indexes and an investment risk on this proposed investment securities are compared. The computer 1 outputs messages, which indicate the characteristics of the compound investment risks in the case of investing in a combination of the selected proposed investment securities, in accordance with the calculated deviations according to the risk indexes (step S105).

As a result, the deviations according to risk indexes of compound investment risks on proposed investment securities selected in response to input for requesting the specification of proposed investment securities from risk standard values are calculated. Computer 1 outputs a message which indicates the characteristics of compound investment risks in the case of investing in a combination of the selected proposed investment securities according to these deviations. This enables a user to realize easily an investment risk in the case of purchasing of securities specified in response to the input for requesting the specification of proposed investment securities entails.

If an employee without advanced expertise of, for example, a securities company who sells securities uses a securities selection support method according to the present invention, he/she can easily give a customer an explanation of the characteristics of a compound investment risk in the case of investing in a combination of securities selected by the customer. As a result, a method for managing an investor's financial assets most suitable to his/her investment needs can be suggested and the business of inviting an investor to manage his/her financial assets can be conducted smoothly. In addition, an investor can clearly grasp a compound investment risk on proposed investment securities he/she selects, so he/she can reliably purchase issues which conform to his/her investment policy.

To realize the securities selection support method according to the present invention shown in FIG. 1 by the computer 1, the computer 1 should be made to execute a program (securities selection support program) in which the procedure for processes in the securities selection support method is described. The computer 1 which executes the securities selection support program functions as a securities selection support unit. Therefore, embodiments of a securities selection support unit to which the present invention is applied will now be described concretely.

[First Embodiment]

A first embodiment will now be described. In the first embodiment, the characteristics of a compound investment risk on selected securities are displayed in the form of a message (characteristic indication message) and this compound investment risk is displayed visually and simply by the use of a diagram. Moreover, in the first embodiment, a user can optionally select a set of issues (issue group) from which risk standard values are calculated. These issue groups include issues (all of the issues listed on the Tokyo Stock Exchange First Section) from which the Tokyo Stock Price Index (TOPIX) is calculated and issues (representative 225 issues) from which the Nikkei Stock Average (Nikkei 225) is calculated.

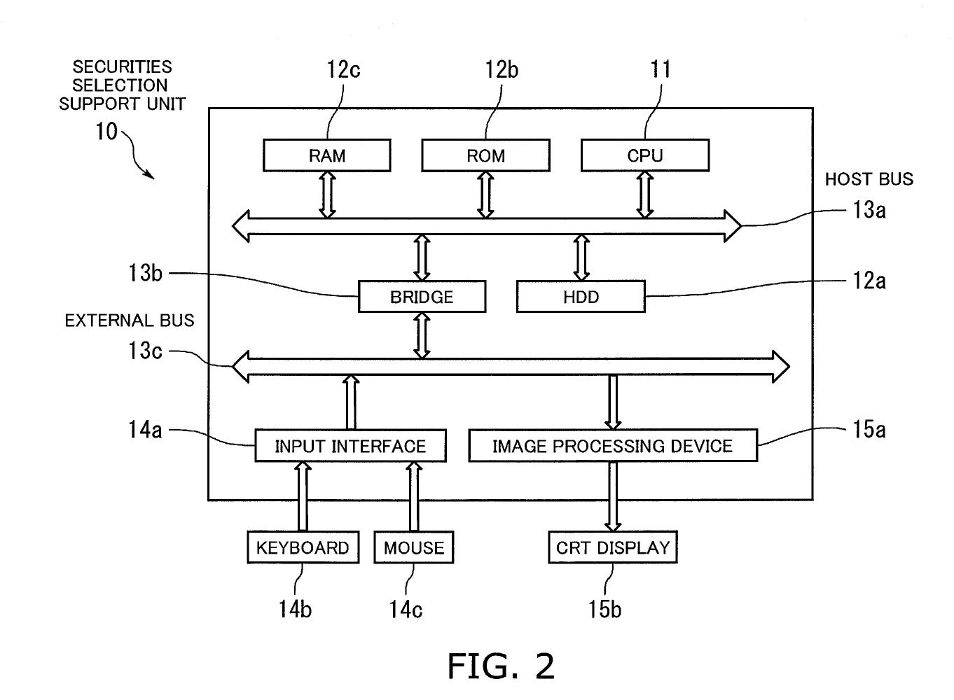

FIG. 2 is a block diagram showing the hardware structure of a securities selection support unit according to the first embodiment.

As shown in FIG. 2, a securities selection support unit 10 includes a central processing unit (CPU) 11, hard disk drive (HDD) 12a, read only memory (ROM) 12b, random access memory (RAM) 12c, host bus 13a, bridge 13b, external bus 13c, input interface 14a, keyboard 14b, mouse 14c, image processing device 15a, and cathode-ray tube (CRT) display 15b.

The CPU 11, HDD 12a, ROM 12b, and RAM 12c are connected to the host bus 13a so that they can exchange information. The external bus 13c is connected to the host bus 13a via the bridge 13b so that they can exchange information. The input interface 14a and image processing device 15a are connected to the external bus 13c so that they can exchange information. The keyboard 14b and mouse 14c are connected to the input interface 14a so that they can exchange information. The CRT display 15b is connected to the image processing device 15a so that the image processing device 15a can send information to the CRT display 15b.

The CPU 11 consists mainly of, for example, a processor and executes various programs, such as an operating system and application programs stored in the ROM 12b or RAM 12c, in synchronization with clock signals supplied from a clock signal generator (not shown).

The HDD 12a is, for example, a fixed storage unit. The ROM 12b is, for example, a mask ROM. The RAM 12c is, for example, a dynamic random access memory (DRAM). The HDD 12a, ROM 12b, and RAM 12c store various programs, such as an operating system and application programs, and various pieces of data and the like necessary for executing a program under the control of the CPU 11.

The host bus 13a and external bus 13c are information transmission lines including a microprocessor and memory. The bridge 13b relays data exchanged between the host bus 13a and external bus 13c.

The input interface 14a relays input signals from the keyboard 14b and mouse 14c to the external bus 13c.

The image processing device 15a generates, for example, analog signals corresponding to analog or digital image data supplied from the external bus 13c under the control of the CPU 11. The image processing device 15a provides the analog signals to the CRT display 15b.

The CRT display 15b is a display of a cathode-ray tube type on which images are displayed by irradiating fluorescent materials on a screen surface with electron beams. The CRT display 15b displays images on the basis of analog signals supplied from the image processing device 15a.

The functions of the securities selection support unit 10 according to the first embodiment can be realized by the above hardware structure.

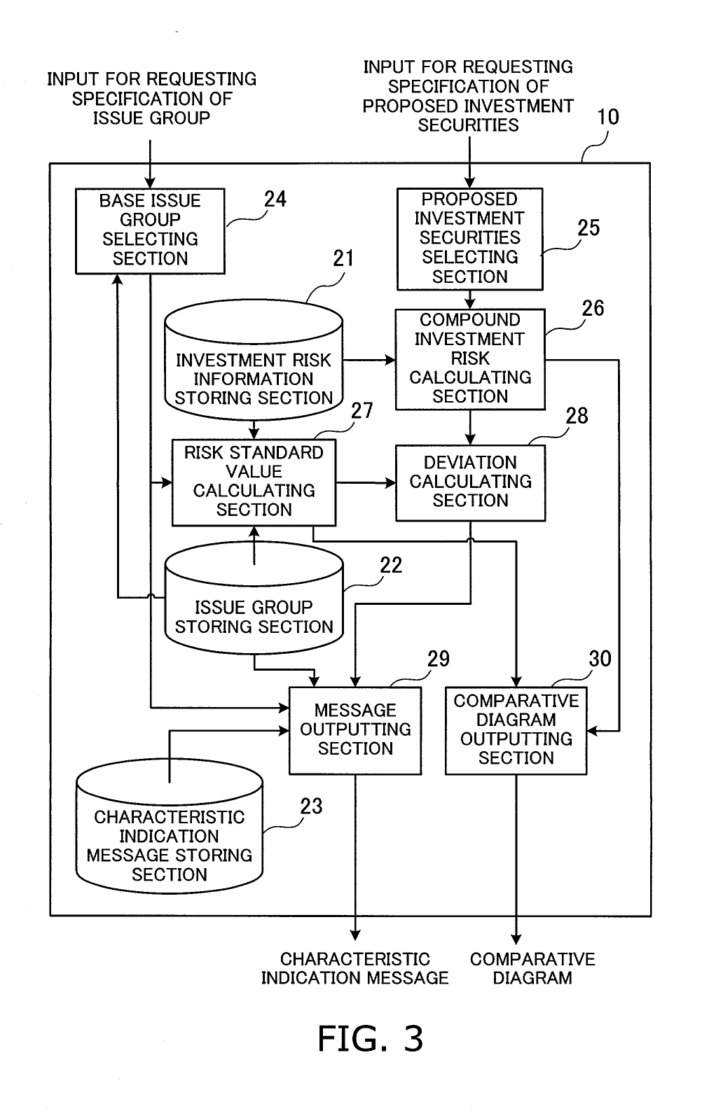

FIG. 3 is a block diagram showing the functions of the securities selection support unit according to the first embodiment. The securities selection support unit 10 according to the first embodiment comprises an investment risk information storing section 21, issue group storing section 22, characteristic indication message storing section 23, base issue group selecting section 24, proposed investment securities selecting section 25, compound investment risk calculating section 26, risk standard value calculating section 27, deviation calculating section 28, message outputting section 29, and comparative diagram outputting section 30.

The investment risk information storing section 21 stores in advance information (investment risk information) regarding a plurality of risk indexes set in advance for each of a plurality of securities designations. Risk indexes are numeric values which represent investment risks, such as Value to Price and Trading Activity. For example, a great value of Value to Price means that the stock is undervalued. That is to say, the risk of a fall in the stock price after investment is low. A great value of Trading Activity means that desired trading is concluded easily. That is to say, the risk of the stock not being marketable is low. The Barra model, for example, can be used as risk indexes for each issue.

In the first embodiment, it is assumed that investment risk information based on TOPIX issues is created in advance. Therefore, if a comparative diagram is displayed in the form of a radar chart, a deviation from a TOPIX risk standard value is considered in principle as the value of each axis indicative of a risk index.

Issue groups for calculating risk standard values are registered in advance with the issue group storing section 22. For example, the set of issues on the basis of which the TOPIX is calculated and the set of issues on the basis of which the Nikkei 225 is calculated are registered.

Character strings for characteristic indication messages are registered with the characteristic indication message storing section 23. For example, a characteristic indication message is set for each of a plurality of numerical ranges into which a risk index is divided.

The base issue group selecting section 24 selects a base issue group from among issue groups registered with the issue group storing section 22 in response to input for requesting the specification of an issue group. For example, this input is supplied from a user by the keyboard 14b and mouse 14c. The base issue group selecting section 24 informs the risk standard value calculating section 27 and message outputting section 29 of identification information (the name of an issue group, for example) regarding a base issue group it selected.

The proposed investment securities selecting section 25 selects proposed investment securities in response to input for requesting the specification of proposed investment securities. For example, when the issue, securities code (symbol for identifying the issue of a listed or over-the-counter introduced stock or listed bond), or the like of securities is input, the proposed investment securities selecting section 25 selects the corresponding securities as proposed investment securities. The proposed investment securities selecting section 25 passes identification information (issues or securities codes) regarding the proposed investment securities to the compound investment risk calculating section 26. The proposed investment securities selecting section 25 can select a plurality of proposed investment securities.

The compound investment risk calculating section 26 obtains investment risk information regarding proposed investment securities from the investment risk information storing section 21 on the basis of identification information for proposed investment securities received from the proposed investment securities selecting section 25. The compound investment risk calculating section 26 calculates compound investment risks according to risk indexes in the case of combining the selected proposed investment securities on the basis of the investment risk information. A compound investment risk in the case of combining a plurality of proposed investment securities is calculated by, for example, averaging the values of risk indexes, which are set for each of the proposed investment securities, according to the risk indexes. The compound investment risk calculating section 26 passes the compound investment risks to the deviation calculating section 28 and comparative diagram outputting section 30.

The risk standard value calculating section 27 obtains issue group information corresponding to a base issue group selected by the base issue group selecting section 24 from the issue group storing section 22. For example, if the TOPIX is selected as a base issue group, the risk standard value calculating section 27 obtains a list of the issues (which are listed on the Tokyo Stock Exchange First Section) used for calculating the TOPIX from the issue group storing section 22.

In addition, the risk standard value calculating section 27 obtains investment risk information regarding each of issues included in the base issue group from the investment risk information storing section 21. The risk standard value calculating section 27 calculates investment risks (risk standard values) according to risk indexes on the base issue group on the basis of the investment risk information. These risk standard values are calculated by, for example, averaging the values of the risk indexes, which are set for proposed investment securities included in the base issue group, according to the risk indexes. The risk standard value calculating section 27 passes the risk standard values to the deviation calculating section 28 and comparative diagram outputting section 30.

The deviation calculating section 28 compares compound investment risks received from the compound investment risk calculating section 26 and risk standard values received from the risk standard value calculating section 27 according to risk indexes and calculates the deviations of the compound investment risks from the risk standard values according to the risk indexes. The deviation calculating section 28 passes the deviations of the compound investment risks according to the risk indexes to the message outputting section 29.

When the message outputting section 29 receives the deviations of compound investment risks according to risk indexes from the deviation calculating section 28, it arranges (sorts) the risk indexes in descending order of absolute value of deviation. The message outputting section 29 selects the sorted risk indexes in descending order of deviation. Moreover, the message outputting section 29 obtains a characteristic indication message corresponding to the deviation of the risk index from the characteristic indication message storing section 23.

In addition, the message outputting section 29 puts the name of a base issue group selected by the base issue group selecting section 24 into a predetermined position in the characteristic indication message. The message outputting section 29 outputs the characteristic indication message into which the name of the base issue group is inserted to the CRT display 15b to make it display the characteristic indication message.

The comparative diagram outputting section 30 draws a comparative diagram on the basis of compound investment risks received from the compound investment risk calculating section 26 and risk standard values received from the risk standard value calculating section 27 to compare the compound investment risks and risk standard values visually. The comparative diagram outputting section 30 draws up a radar chart with risk indexes as axes, for example, as a comparative diagram. The comparative diagram outputting section 30 outputs the comparative diagram to the CRT display 15b to make the CRT display 15b display the comparative diagram.

Concrete examples of information stored in the investment risk information storing section 21, issue group storing section 22, and characteristic indication message storing section 23 will now be described.

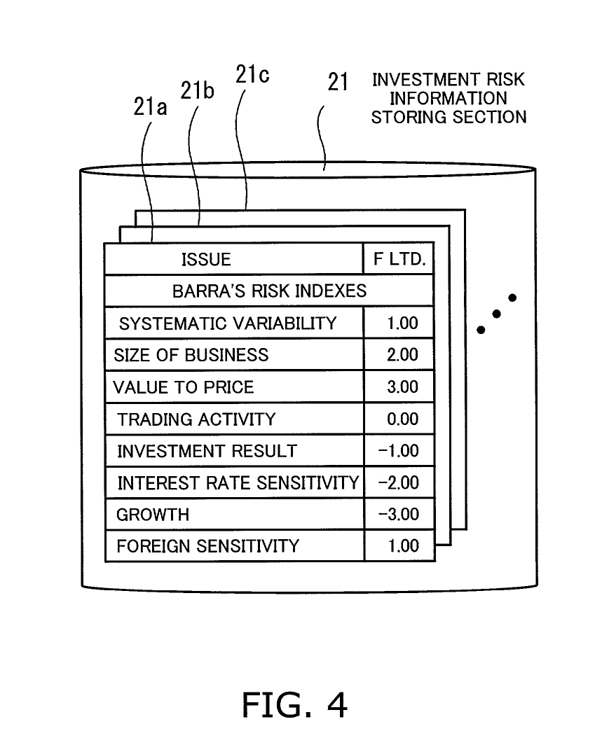

FIG. 4 is a view showing an example of investment risk information stored in the investment risk information storing section 21. The investment risk information storing section 21 stores investment risk information 21a, 21b, 21c, . . . according to securities. An issue and the value of each of the risk indexes (Barra's risk indexes) used in the Barra risk model are set in each of the investment risk information 21a, 21b, 21c, . . . .

In the investment risk information 21a, for example, “F Ltd.” is set as Issue. “1.00,” “2.00,” “3.00,” “0.00,” “−1.00,” “−2.00,” “−3.00,” and “1.00” are set as Systematic Variability, Size of Business, Value to Price, Trading Activity, Investment Result, Interest Rate Sensitivity, Growth, and Foreign Sensitivity, respectively, which are the Barra's risk indexes.

Systematic Variability is an index which indicates, for example, the volatility of a securities earning rate to the market on the basis of historical data. A great value of Systematic Variability means that this volatility is great.

Size of Business is an index which represents both corporate total assets and market capitalization, for example, in order to distinguish large capital stock and small capital stock. A great value of Size of Business means a large size of business.

Value to Price is an index which indicates, for example, whether a stock price is undervalued or overvalued in the market from corporate affairs and management performance. A great value of Value to Price means that a stock price is undervalued.

Trading Activity is an index which indicates, for example, the turnover ratio of each of securities. A great value of Trading Activity means that transactions are performed actively.

Investment Result is an index which indicates, for example, how the rate of returns on the stock to be evaluated exceeded the TOPIX for a medium or long term in the past. A great value of Investment Result means that the rate of returns on the stock to be evaluated exceeded the TOPIX significantly.

Interest Rate Sensitivity is an index which indicates, for example, the sensitivity of returns on stock to a change in interest rate. A great value of Interest Rate Sensitivity means great sensitivity of returns on stock to a change in interest rate.

Growth is an index which indicates, for example, the growth potential of corporate sales and total assets in the past six years. A great value of Growth means that this growth potential is high.

Foreign Sensitivity is an index which indicates, for example, the degree of the influence of overseas business and economic events on the rate of returns on stock. A great value of Foreign Sensitivity means that exchange fluctuations, oil price fluctuations, and the like have a great influence on the rate of returns on the stock.

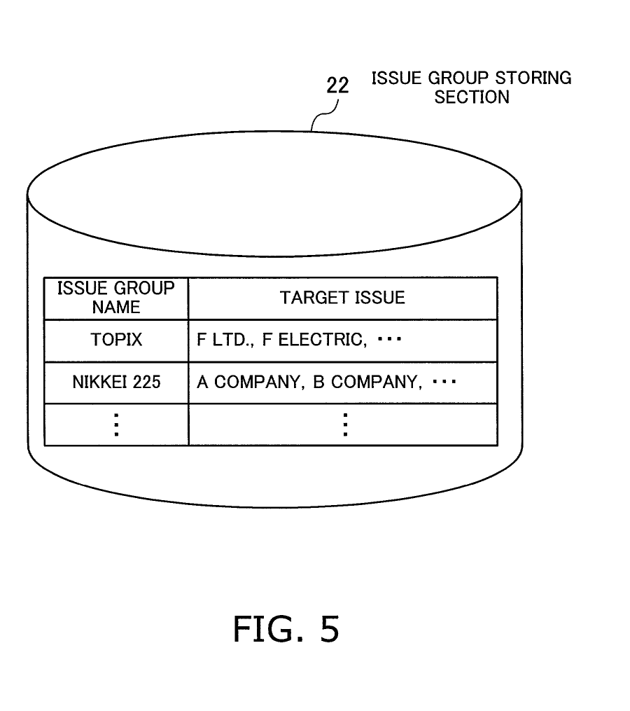

FIG. 5 is a view showing an example of issue groups stored in the issue group storing section 22. The names of issue groups (Issue Group Name) and lists of issues (Target Issue) included in these issue groups are associated according to the issue groups and are registered with the issue group storing section 22.

In this example, “TOPIX,” “Nikkei 225,” etc. are registered as issue groups under Issue Group Name. The issues listed on the Tokyo Stock Exchange First Section are registered on a list of target issues corresponding to “TOPIX.” The representative 225 issues among the issues listed on the Tokyo Stock Exchange First Section are registered on a list of target issues corresponding to “Nikkei 225.”

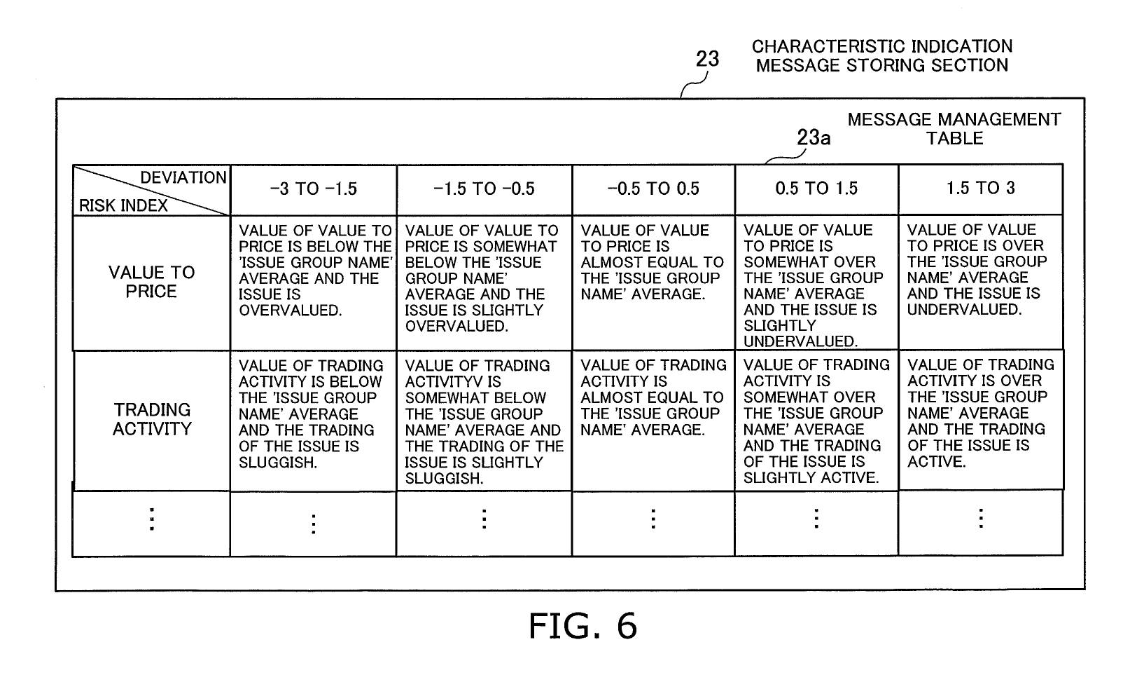

FIG. 6 is a view showing an example of characteristic indication messages stored in the characteristic indication message storing section 23. In the characteristic indication message storing section 23, character strings indicative of characteristic indication messages are managed by a message management table 23a.

Characteristic indication messages according to deviation ranges are registered in the message management table 23a and are associated with risk indexes. In this example, Value to Price, Trading Activity, etc. are registered as risk indexes. There are five deviation ranges: “−3 to −1.5 (greater than or equal to −3 and smaller than −1.5),” “−1.5 to −0.5 (greater than or equal to −1.5 and smaller than −0.5),” “−0.5 to 0.5 (greater than or equal to −0.5 and smaller than 0.5),” “0.5 to 1.5 (greater than or equal to 0.5 and smaller than 1.5),” and “1.5 to 3 (greater than or equal to 1.5 and smaller than or equal to 3).”

Characteristic indication messages registered in the message management table 23a include an unfixed character string “issue group name.” For example, if a deviation corresponding to the risk index Value to Price is “−3 to −1.5,” the character string “Value of Value to Price is below the ‘issue group name’ average and the issue is overvalued.” is registered as a characteristic indication message. When a characteristic indication message is displayed, the issue group name of a base issue group selected in that case will be put into the position where the unfixed character string is. For example, if “TOPIX” has been selected as a base issue group, the unfixed character string “issue group name” will be replaced by “TOPIX” and a characteristic indication message will be displayed. 4

A process performed by the securities selection support unit 10 having the above structure will now be described.

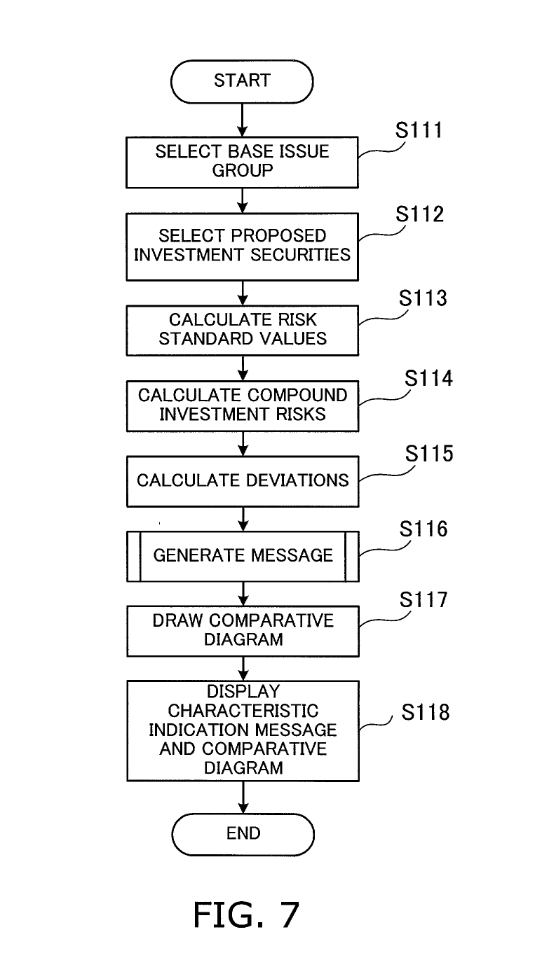

FIG. 7 is a flow chart showing a procedure for all the process of supporting the selection of securities. The process shown in FIG. 7 will now be described in order of step number.

[Step S111] The base issue group selecting section 24 selects one issue group from among issue groups registered with the issue group storing section 22 in response to input for requesting the specification of an issue group. The base issue group selecting section 24 informs the risk standard value calculating section 27 and message outputting section 29 of the name of an issue group it selected.

[Step S112] The proposed investment securities selecting section 25 selects one or more proposed investment securities in response to input for requesting the specification of proposed investment securities. For example, a plurality of securities will be selected by combining a stock, investment trust, etc. The proposed investment securities selecting section 25 informs the compound investment risk calculating section 26 of the designations of proposed investment securities it selected.

The order of step S111 and step S112 may be reversed.

[Step S113] The risk standard value calculating section 27 refers to investment risk information registered with the investment risk information storing section 21 and calculates risk standard values on the basis of investment risk information regarding issues includes in the selected base issue group. The risk standard value calculating section 27 passes the risk standard values to the deviation calculating section 28.

[Step S114] The compound investment risk calculating section 26 refers to investment risk information registered with the investment risk information storing section 21 and calculates compound investment risks in the case of combining the selected proposed investment securities. The compound investment risk calculating section 26 passes the compound investment risks to the deviation calculating section 28 and comparative diagram outputting section 30.

The order of step S113 and step S114 may be reversed.

[Step S115] The deviation calculating section 28 calculates the deviations of the compound investment risks it received from the compound investment risk calculating section 26 on the basis of the risk standard values it received from the risk standard value calculating section 27 according to risk indexes. The deviation calculating section 28 passes the deviations to the message outputting section 29 and comparative diagram outputting section 30.

[Step S116] The message outputting section 29 generates a characteristic indication message corresponding to a combination of proposed investment securities. The details of the process of generating a message will be described later.

[Step S117] The comparative diagram outputting section 30 draws a comparative diagram to compare the risk standard values calculated by the risk standard value calculating section 27 and the compound investment risks calculated by the compound investment risk calculating section 26. A radar chart on which risk indexes are used as axes will be drawn up as a comparative diagram.

[Step S118] The message outputting section 29 causes the characteristic indication message to be displayed and the comparative diagram outputting section 30 causes the comparative diagram to be displayed.

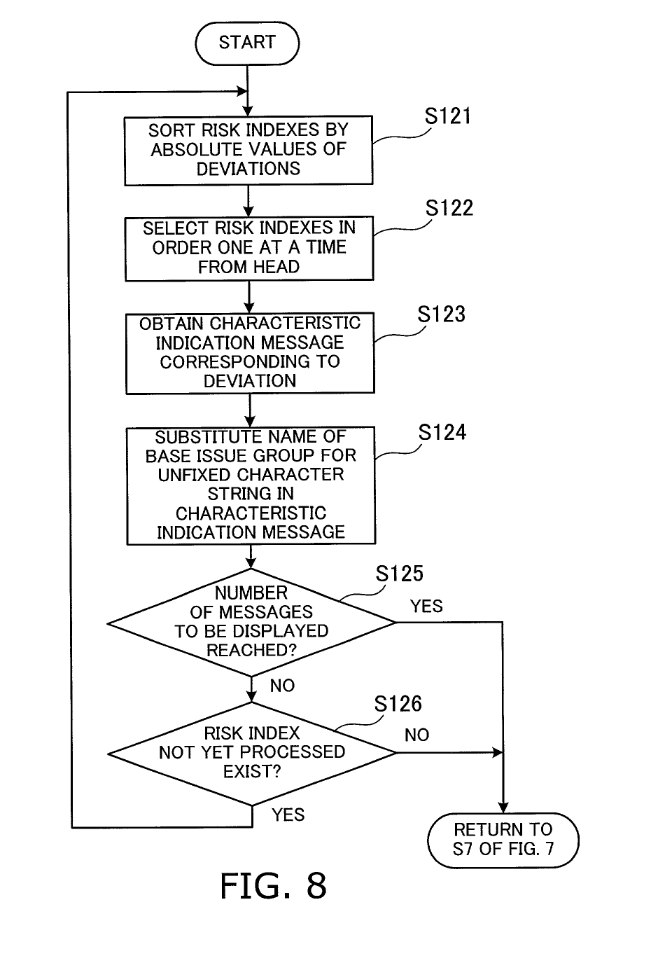

FIG. 8 is a flow chart showing a procedure for the process of generating a message. The process shown in FIG. 8 will now be described in order of step number.

[Step S121] The message outputting section 29 sorts risk indexes by absolute values of deviations. That is to say, the message outputting section 29 arranges risk indexes in descending order of deviation from risk standard value.

[Step S122] The message outputting section 29 selects risk indexes in order one at a time from the head of the sorted array.

[Step S123] The message outputting section 29 obtains a characteristic indication message corresponding to a deviation from among characteristic indication messages which are associated with a selected risk index and which are stored in the characteristic indication message storing section 23. That is to say, a characteristic indication message corresponding to a range including a deviation calculated by the deviation calculating section 28 will be obtained (for example, if a deviation is −2, a deviation range is −3 to −1.5).

[Step S124] The message outputting section 29 substitutes the name of a base issue group for an unfixed character string “issue group name” in the characteristic indication message.

[Step S125] The message outputting section 29 judges whether or not the number of the risk indexes has reached that of messages to be displayed. The number of messages to be displayed is set in advance according to, for example, the structure of a screen on which they are displayed. If the number of the selected risk indexes has reached that of messages to be displayed, step S117 shown in FIG. 7 is performed. If the number of the selected risk indexes has not reached that of messages to be displayed, the process of generating a message terminates and step S126 is performed.

[Step S126] The message outputting section 29 judges whether there is a risk index which is not yet processed. If there is a risk index which is not yet processed, step S121 will be performed. If there is no risk index that is not yet processed, the process of generating a message terminates and step S117 shown in FIG. 7 is performed.

As a result of the above processes performed by the securities selection support unit 10, the characteristics of compound investment risks on the selected proposed investment securities will be displayed as messages and a comparative diagram which indicates the deviations of the compound investment risks from standard values will be displayed.

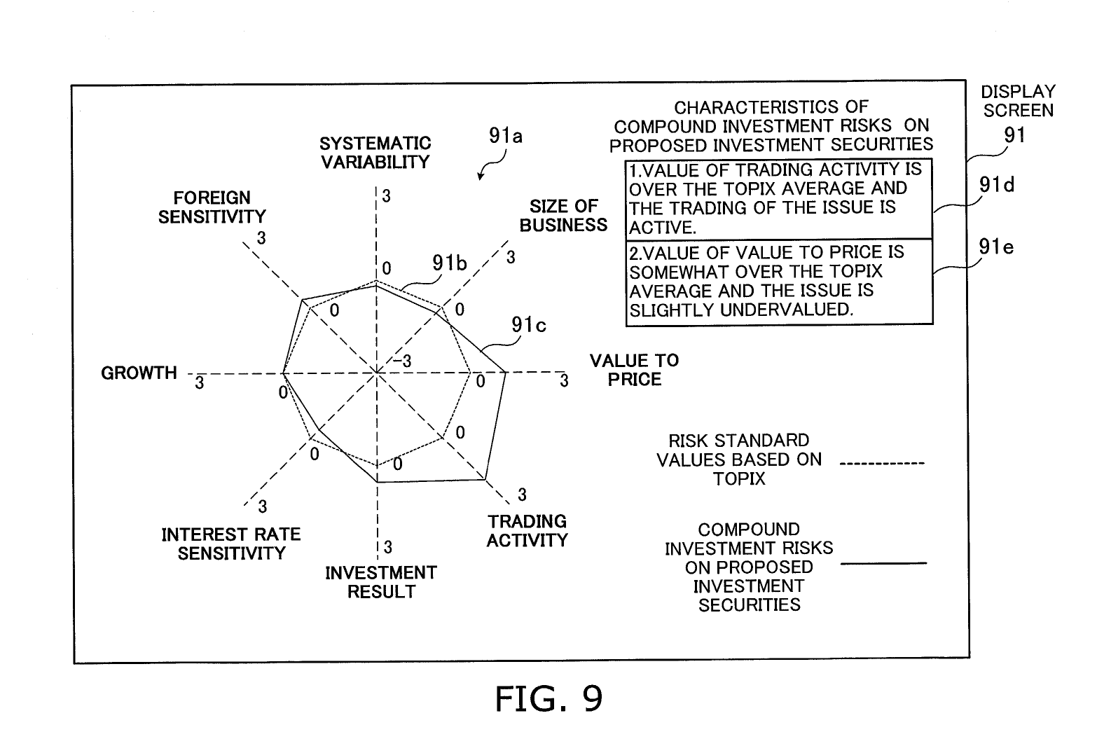

FIG. 9 is a view showing an example of a display screen indicating the characteristics of an investment risk. A display screen 91 will appear when the TOPIX is selected as a base issue group. On the display screen 91, a radar chart 91a drawn up by the comparative diagram outputting section 30 and characteristic indication messages 91d and 91e generated by the message outputting section 29 are displayed.

On the radar chart 91a, the Barra's risk indexes are set as axes. A value on each axis indicates a deviation from a risk standard value based on the TOPIX. On the radar chart 91a shown in FIG. 9, risk standard values calculated on the basis of the TOPIX are indicated by a dotted line 91b. Compound investment risks on proposed investment securities are indicated by a solid line 91c.

The characteristic indication messages 91d and 91e are displayed from the top in descending order of absolute value of deviation. In this example, the absolute value of the deviation of a value of Trading Activity is the greatest and absolute value of the deviation of a value of Value to Price is the second greatest. Therefore, the characteristic indication message 91d regarding Trading Activity and characteristic indication message 91e regarding Value to Price are displayed in that order.

The characteristic indication message 91d corresponds to a deviation range regarding Trading Activity of 1.5 to 3. An unfixed character string in the characteristic indication message 91d has been replaced by “TOPIX.” The characteristic indication message 91e corresponds to a deviation range regarding Value to Price of 0.5 to 1.5. An unfixed character string in the characteristic indication message 91e has been replaced by “TOPIX.”

When an investor looks at the display screen 91, he/she can easily grasp the characteristics of compound investment risks in the case of purchasing proposed investment securities he/she selected. In this case, if he/she desires that Value to Price, for example, should become larger instead of Trading Activity, other proposed investment securities will be selected to replace one or more proposed investment securities. As a result, compound investment risks on proposed investment securities are recalculated and the display screen 91 is updated.

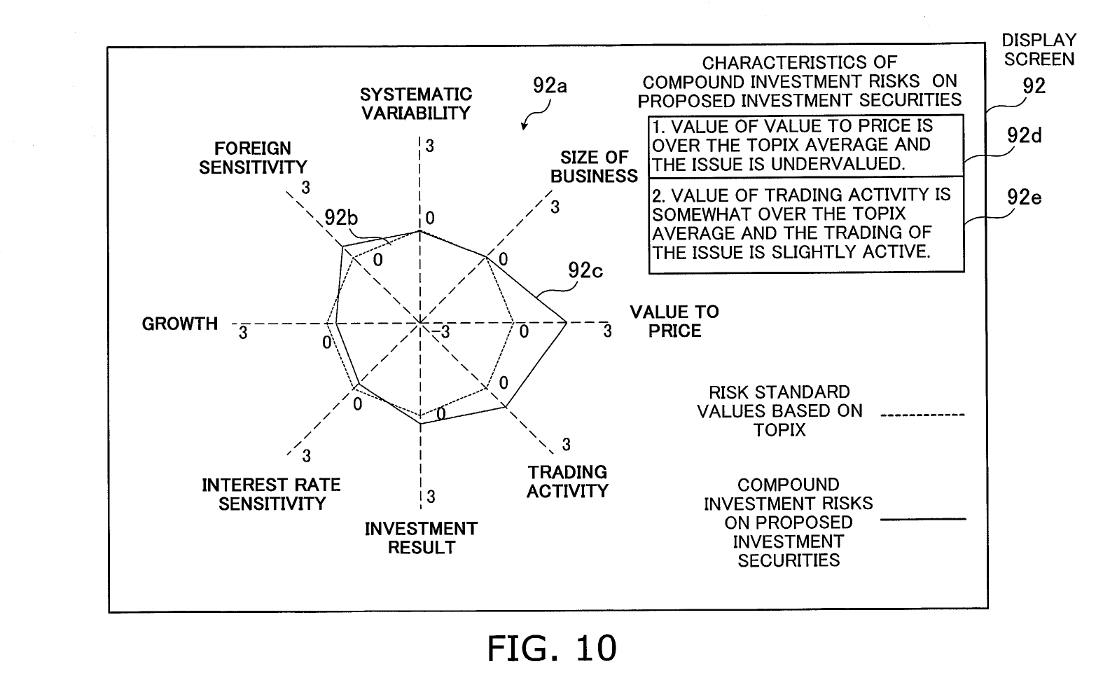

FIG. 10 is a view showing an example of a display screen which appears after proposed investment securities being changed. On a display screen 92, a radar chart 92a and characteristic indication messages 92d and 92e are displayed. The shape of a dotted line 92b on the radar chart 92a indicative of risk standard values based on the TOPIX is the same as that of the dotted line 91b on the display screen 91 (shown in FIG. 9). On the other hand, proposed investment securities were changed, so the shape of a solid line 92c indicative of compound investment risks on proposed investment securities is different from that of the solid line 91c on the display screen 91 (shown in FIG. 9). To be concrete, in this example, the deviation of Value to Price increases and the deviation of Trading Activity decreases.

Therefore, a characteristic indication message 92d regarding Value to Price is displayed at the top and a characteristic indication message 92e regarding Trading Activity is displayed under it. Moreover, the contents of the characteristic indication message 92d regarding Value to Price have been changed so that they will correspond to a deviation range of 1.5 to 3. The contents of the characteristic indication message 92e regarding Trading Activity have been changed so that they will correspond to a deviation range of 0.5 to 1.5.

By changing proposed investment securities in this way, a combination of securities which entails compound investment risks corresponding to an investor's desire can be found. As a result, a combination of securities which meets an investor's needs can be suggested from among a vast number of securities without a profound knowledge security analysts have.

In addition, by changing a base issue group from the TOPIX to another issue group, indexes suitable for an issue considered as an investment choice can be obtained. For example, if an investor intends to make an investment in a telecommunication-related issue, risk standard values should be strongly influenced by telecommunication-related issues. Therefore, by selecting the Nikkei 225 (it is assumed that the proportion of telecommunication-related issues in the Nikkei 225 is higher than that of telecommunication-related issues in the TOPIX) as a base issue group, risk standard values which are strongly influenced by telecommunication-related issues can be obtained. When a base issue group is changed, a display screen will be updated.

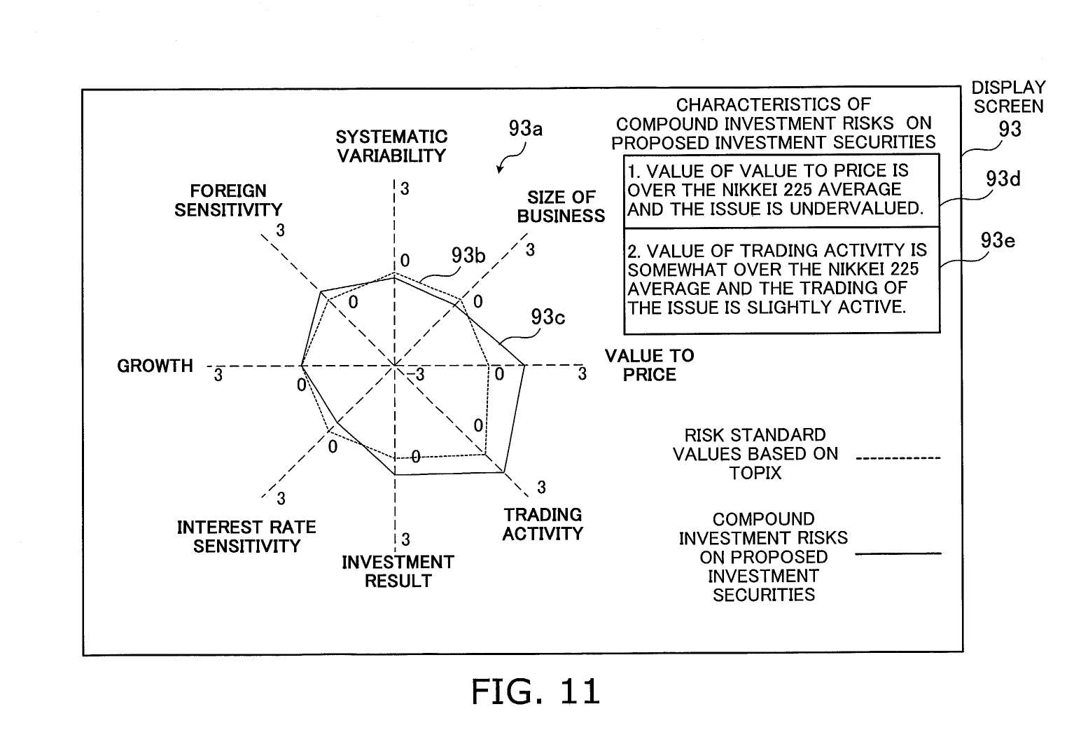

FIG. 11 is a view showing an example of a display screen which appears after a base issue group being changed. A display screen 93 will appear when the base issue group is changed on the display screen 91 shown in FIG. 9. On the display screen 93, a radar chart 93a and characteristic indication messages 93d and 93e are displayed.

In this example, axes on the radar chart 93a are indicated by deviations from risk standard values based on the TOPIX. This is the same with FIG. 9. That is to say, risk standard values based on the Nikkei 225 are also indicated by deviations from risk standard values based on the TOPIX. Therefore, the shape of a dotted line 93b on the radar chart 93a indicative of risk standard values based on the Nikkei 225 is different from that of the dotted line 91b on the display screen 91 (shown in FIG. 9) indicative of risk standard values based on the TOPIX. To be concrete, in this example, the deviation of Trading Activity increases. On the other hand, the proposed investment securities were changed, so the shape of a solid line 93c indicative of compound investment risks on proposed investment securities is the same as that of the solid line 91c on the display screen 91 (shown in FIG. 9).

As a result, among the deviations of compound investment risks from risk standard values based on the Nikkei 225, the deviation of Value to Price is the greatest and the deviation of Trading Activity is the second greatest. Therefore, a characteristic indication message 93d regarding Value to Price is displayed at the top and a characteristic indication message 93e regarding Trading Activity is displayed under it. Moreover, the contents of the characteristic indication message 93d regarding Value to Price have been changed so that they will correspond to a deviation range of 1.5 to 3. The contents of the characteristic indication message 93e regarding Trading Activity have been changed so that they will correspond to a deviation range of 0.5 to 1.5. In addition, unfixed character strings in the characteristic indication messages 93d and 93e have been replaced by “Nikkei 225.”

By changing a base issue group in this way, risk standard values corresponding to a market in which an investor intends to make an investment can be obtained. As a result, accurate characteristic indication messages regarding compound investment risks can be displayed according to an investor's investment policy.

In this example, after a base issue group being changed to the Nikkei 225, values on the axes on the radar chart 93a are based on risk standard values calculated on the basis of the TOPIX. However, values on the axes on the radar chart 93a may be changed to ones based on risk standard values calculated on the basis of the Nikkei 225.

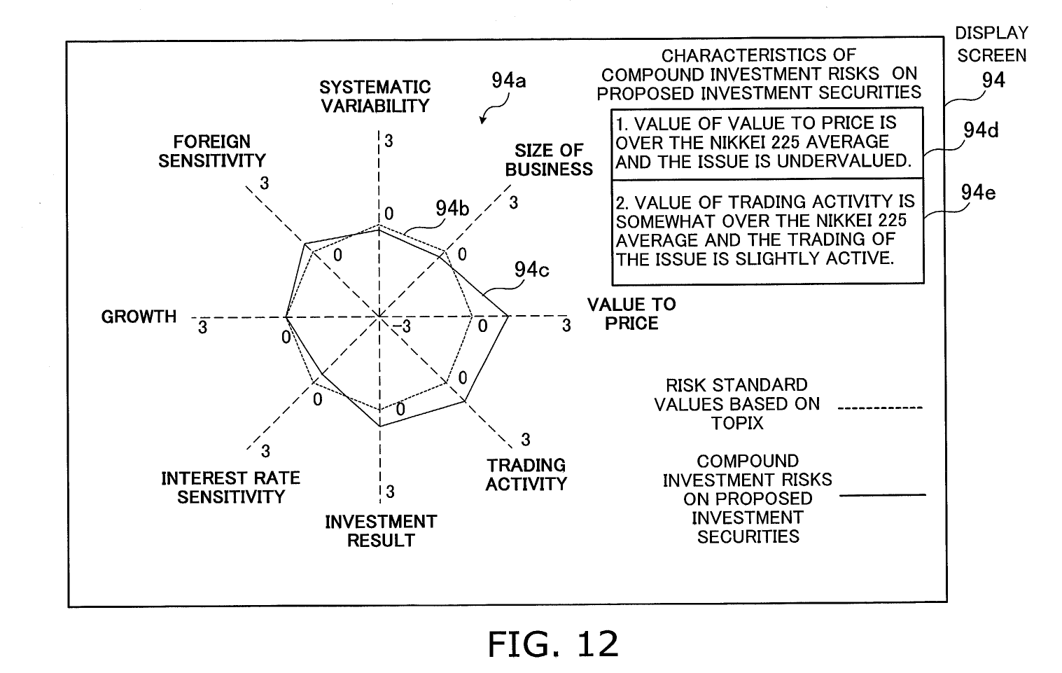

FIG. 12 is a view showing an example of a display screen which appears when a standard for axes on a radar chart is changed with a change of base issue group. A display screen 94 will appear when the base issue group is changed on the display screen 91 shown in FIG. 9. On the display screen 94, a radar chart 94a and characteristic indication messages 94d and 94e are displayed.

Unlike FIG. 9, in this example, axes on the radar chart 94a are indicated by deviations from risk standard values based on the Nikkei 225. Therefore, a dotted line 94b indicative of risk standard values based on the Nikkei 225 intersects each axis at the origin (a point corresponding to the value of 0). A standard for the axes changes, so the shape of a solid line 94c indicative of compound investment risks on proposed investment securities will be changed. In this example, the deviation of Trading Activity decreases.

As a result, among the deviations of compound investment risks from risk standard values calculated on the basis of the Nikkei 225, the deviation of Value to Price is the greatest and the deviation of Trading Activity is the second greatest. Therefore, a characteristic indication message 94d regarding Value to Price is displayed at the top and a characteristic indication message 94e regarding Trading Activity is displayed under it. Moreover, the contents of the characteristic indication message 94d regarding Value to Price have been changed so that they will correspond to a deviation range of 1.5 to 3. The contents of the characteristic indication message 94e regarding Trading Activity have been changed so that they will correspond to a deviation range of 0.5 to 1.5. In addition, unfixed character strings in the characteristic indication messages 94d and 94e have been replaced by “Nikkei 225.”

[Second Embodiment]

A second embodiment will now be described. In the second embodiment, securities which satisfy an investor's investment needs are automatically selected with a computer and the characteristics of compound investment risks on the securities automatically selected are specified as expected values in the form of messages and radar charts. This will contribute toward smoothing the business of inviting an investor to manage his/her financial assets. Therefore, in the second embodiment, an asset management invitation unit to which the present invention is applied will be described concretely.

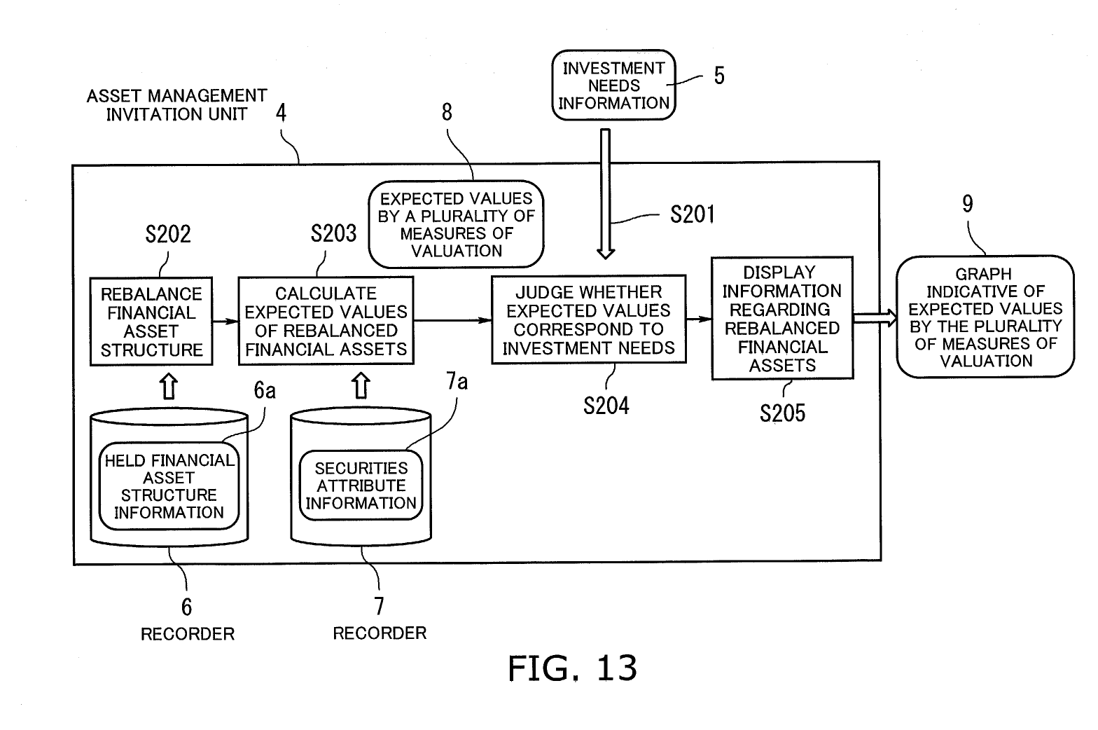

FIG. 13 is a schematic view showing the structure of an asset management invitation unit. As shown in FIG. 13, a recorder 7, for example, in an asset management invitation unit 4 stores securities attribute information 7a, being information indicative of the attributes of securities included in financial assets. A recorder 6 stores held financial asset structure information 6a, being information indicative of the structure of held financial assets being financial assets held by an investor.

First, an investor who intends to receive a suggestion regarding his/her financial assets by the asset management invitation unit 4 inputs investment needs information 5, being information indicative of his/her investment needs regarding his/her financial assets (step S201). In this case, investment needs mean investment conditions, such as earnings an investor expects from his/her financial assets and an investment budget.

Then the asset management invitation unit 4 changes at least part of held financial assets indicated in the held financial asset structure information 6a stored in the recorder 6 to other securities (step S202) Moreover, the asset management invitation unit 4 calculates expected values 8 by a plurality of measures of valuation of the rebalanced financial assets, being the held financial assets at least part of which have been changed to other securities, by the use of the securities attribute information 7a stored in the recorder 7 (step S203).

Then the asset management invitation unit 4 judges whether the expected values 8 of the rebalanced financial assets calculated in step S203 correspond to the investment needs indicated in the investment needs information 5 input in step S201 (step S204) Finally the asset management invitation unit 4 visually displays the expected values 8 (by the plurality of measures of valuation) of the rebalanced financial assets judged to be correspondent to the investment needs in the form of a graph 9 (indicative of the expected values by the plurality of measures of valuation) (step S205).

This enables a user of the asset management invitation unit 4 (an employee of a securities company, for example) to display visually information regarding the most suitable financial asset management to investment needs in the form of the graph 9 indicative of expected values by a plurality of measures of valuation only by inputting the investment needs to the asset management invitation unit 4. As a result, a person without advanced expertise can smoothly conduct the business of inviting an investor to manage his/her financial assets.

Especially with a method for inviting asset management by the use of the asset management invitation unit 4, financial asset management which fulfills investment needs will be recommended on the basis of the expected values 8 by a plurality of measures of valuation, so carefully thought-out investment strategies and rebalancing strategies which satisfy investors' various investment needs can be suggested.

In addition, this suggestion will be given by displaying visually expected values corresponding to recommended financial asset management with a graph, so investors can intuitively recognize the contents of carefully thought-out financial asset management suggested according to their various investment needs. As a result, the business of inviting an investor to manage his/her financial assets can be conducted smoothly.

An asset management invitation unit having the function shown in FIG. 13 will now be described concretely.

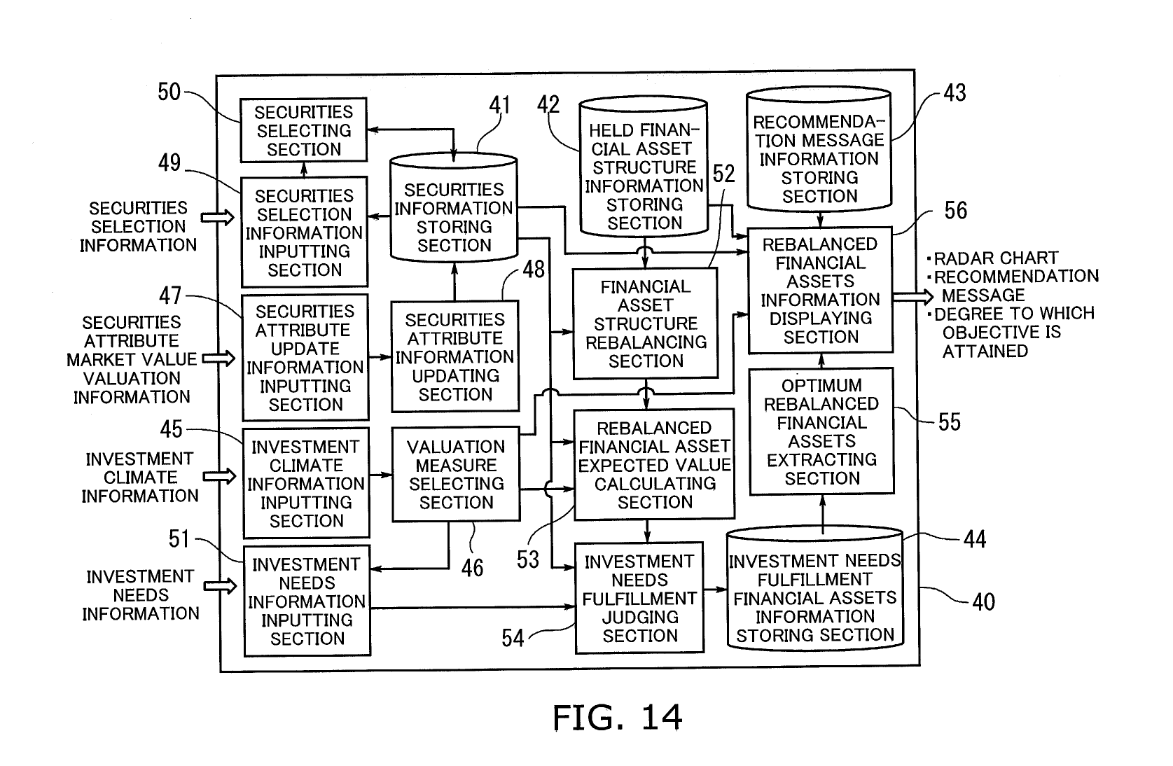

FIG. 14 is a block diagram showing the functions of an asset management invitation unit according to the second embodiment. Each of the functions of an asset management invitation unit 40 shown in FIG. 14 is comprised by concrete means in which the hardware shown in FIG. 2 and a predetermined program (software) cooperate by executing the program on the hardware.

As shown in FIG. 14, the asset management invitation unit 40 includes a securities information storing section 41, held financial asset structure information storing section 42, recommendation message information storing section 43, investment needs fulfillment financial assets information storing section 44 as functions for storing information.

The securities information storing section 41 stores securities attribute information, being information indicative of the attributes (such as size of business and stock price) of securities included in financial assets. The attributes of securities include various indexes on the basis of which investors judge whether to make an investment. For example, the attributes of securities include the Barra's risk indexes.

The held financial asset structure information storing section 42 stores held financial asset structure information, being information indicative of the structure of held financial assets being financial assets held by an investor.

The recommendation message information storing section 43 stores information regarding recommendation messages applied to recommended financial asset management. Recommendation messages are associated with conditions for displaying them.

The investment needs fulfillment financial assets information storing section 44 stores information regarding rebalanced financial assets which is judged by an investment needs fulfillment judging section 54 to be correspondent to investment needs.

The asset management invitation unit 40 includes the investment climate information inputting section 45, a valuation measure selecting section 46, securities attribute update information inputting section 47, securities attribute information updating section 48, securities selection information inputting section 49, securities selecting section 50, investment needs information inputting section 51, financial asset structure rebalancing section 52, rebalanced financial asset expected value calculating section 53, investment needs fulfillment judging section 54, optimum rebalanced financial assets extracting section 55, and rebalanced financial assets information displaying section 56 as processing functions.

The investment climate information inputting section 45 accepts input of investment climate information which indicates an investment climate. An investment climate means a market climate, including stock price averages, interest rates, and exchange rates, which will influence the rate of returns on securities, such as stock. Investment climate information is information which indicates whether the market is steady or stagnant. The investment climate information inputting section 45 passes the investment climate information to the valuation measure selecting section 46.

The valuation measure selecting section 46 selects a measure of valuation according to an investment climate indicated in investment climate information input in the investment climate information inputting section 45. Measures of valuation are used for valuing financial assets. These measures of valuation include systematic variability, size of business, value to price, trading activity, investment result, interest rate sensitivity, growth, and foreign sensitivity. A selected measure of valuation will be used for calculating the expected value of financial assets to value them. An expected value is an expected index to financial assets etc. and means, for example, the numeric value of systematic variability.

Measures of valuation are classified in advance into four categories: “neutral,” “bull,” “bear,” and “stable.” For example, if investment climate information indicates that the market is steady, then the valuation measure selecting section 46 selects a bull measure of valuation (for earning a high yield at a certain measure of risk). If investment climate information indicates that the market is stagnant, then the valuation measure selecting section 46 selects a bear measure of valuation (for decreasing risk and getting returns reliably). The valuation measure selecting section 46 passes the measure of valuation to the investment needs information inputting section 51, rebalanced financial asset expected value calculating section 53, and rebalanced financial assets information displaying section 56.

The securities attribute update information inputting section 47 accepts input of securities attribute market value valuation information, being up-to-date market value information regarding the attributes of securities (size of business, stock price, etc.). The securities attribute update information inputting section 47 passes the securities attribute market value valuation information to the securities attribute information updating section 48.

The securities attribute information updating section 48 updates securities attribute information stored in the securities information storing section 41 by the use of securities attribute market value valuation information passed from the securities attribute update information inputting section 47.

The securities selection information inputting section 49 accepts input of securities selection information, being information used for selecting securities to be added to held financial assets. This securities selection information is information used for narrowing the scope of issues to be invested in by, for example, specifying whether an investment should be made in a highly stable company of high reputation or a venture business with a great future. The securities selection information inputting section 49 passes the securities selection information to the securities selecting section 50.

The securities selecting section 50 selects securities to be added instead to held financial assets by the use of securities selection information passed from the securities selection information inputting section 49. That is to say, the securities selecting section 50 searches the securities information storing section 41 for securities that fulfill or are closer to an investor's investment policy specified in securities selection information. Then the securities selecting section 50 selects securities to be added instead to the held financial assets from among the search results in response to input by the investor and stores information indicative of the selected securities in the securities information storing section 41.

The investment needs information inputting section 51 accepts input of investment needs information, being information indicative of an investor's investment needs about his/her financial assets. This investment needs information indicates an investor's future investment policy. For example, information regarding whether he/she wants to make the current beta (coefficient indicative of the degree of correlation between the fluctuation of all the stock market and the fluctuation of a specific stock) as all of the financial assets greater or smaller will be input as investment needs information. The investment needs information inputting section 51 calculates an expected value for the investor regarding a measure of valuation passed from the valuation measure selecting section 46 on the basis of the input investment needs information. Then the investment needs information inputting section 51 passes the expected values to the investment needs fulfillment judging section 54.

The financial asset structure rebalancing section 52 changes at least part of held financial assets indicated in held financial asset structure information stored in the held financial asset structure information storing section 42 to other securities. Securities to be newly added to the held financial assets were selected by the securities selecting section 50. Information regarding the selected securities can be obtained from the securities information storing section 41. The financial asset structure rebalancing section 52 passes information regarding the components of the financial assets at least part of which were changed (rebalanced financial assets) to the rebalanced financial asset expected value calculating section 53.

The rebalanced financial asset expected value calculating section 53 obtains securities attribute information for rebalanced financial assets passed from the financial asset structure rebalancing section 52 from the securities information storing section 41. Then the rebalanced financial asset expected value calculating section 53 calculates expected values (expected values of the rebalanced financial assets) by measures of valuation passed from the valuation measure selecting section 46 on the basis of the securities attribute information for the rebalanced financial assets. The rebalanced financial asset expected value calculating section 53 passes the expected values of the rebalanced financial assets to the investment needs fulfillment judging section 54.

The investment needs fulfillment judging section 54 judges whether the expected values of rebalanced financial assets (objective expected value of rebalanced financial assets) passed from the rebalanced financial asset expected value calculating section 53 corresponds to expected values based on investment needs (expected values requested by an investor) passed from the investment needs information inputting section 51. Whether they correspond can be judged with certain permissible limits set. If they correspond, then the investment needs fulfillment judging section 54 obtains securities information for the rebalanced financial assets from the securities information storing section 41 and stores it in the investment needs fulfillment financial assets information storing section 44.

The optimum rebalanced financial assets extracting section 55 obtains rebalanced financial assets which are judged by the investment needs fulfillment judging section 54 to be correspondent to investment needs from the investment needs fulfillment financial assets information storing section 44. Then the optimum rebalanced financial assets extracting section 55 extracts the optimum rebalanced financial asset, being rebalanced financial assets that fulfill the investment needs best, from among rebalanced financial assets which are judged by the investment needs fulfillment judging section 54 to be correspondent to the investment needs. The optimum rebalanced financial assets extracting section 55 passes the optimum rebalanced financial assets to the rebalanced financial assets information displaying section 56.

The rebalanced financial assets information displaying section 56 obtains information regarding optimum rebalanced financial assets, which the optimum rebalanced financial assets extracting section 55 extracted, from the securities information storing section 41 and held financial asset structure information storing section 42. By using the information, the rebalanced financial assets information displaying section 56 visually displays the expected values by measures of valuation of the optimum rebalenced financial assets with a graph and displays the degree to which an object is attained (the difference between expected values based on investment needs and the expected values of rebalanced financial assets).

In addition, the rebalanced financial assets information displaying section 56 calculates standard values for measures of valuation from securities information stored in the securities information storing section 41 and obtains recommendation messages according to the deviations of the expected values from the standard values from the recommendation message information storing section 43. Then the rebalanced financial assets information displaying section 56 displays the recommendation messages.

The functions of the securities selection support unit 10 shown in the first embodiment are applied to the functions of displaying a graph and recommendation messages of the rebalanced financial assets information displaying section 56. In the second embodiment, it is assumed that a base issue group in the first embodiment is constant. For example, the issue group used for calculating the TOPIX is used as a base issue group. Optimum rebalanced financial assets in the second embodiment correspond to proposed investment securities in the first embodiment. Recommendation messages in the second embodiment correspond to characteristic indication messages in the first embodiment.

In the first embodiment, a characteristic indication message is displayed if a deviation from the risk standard value is a great value. In the second embodiment, however, a recommendation message is displayed only if the expected value by a measure of valuation (corresponding to an investment risk in the first embodiment based on a risk index) of the best rebalanced financial assets is positive (this means that these assets are suitable for investment).

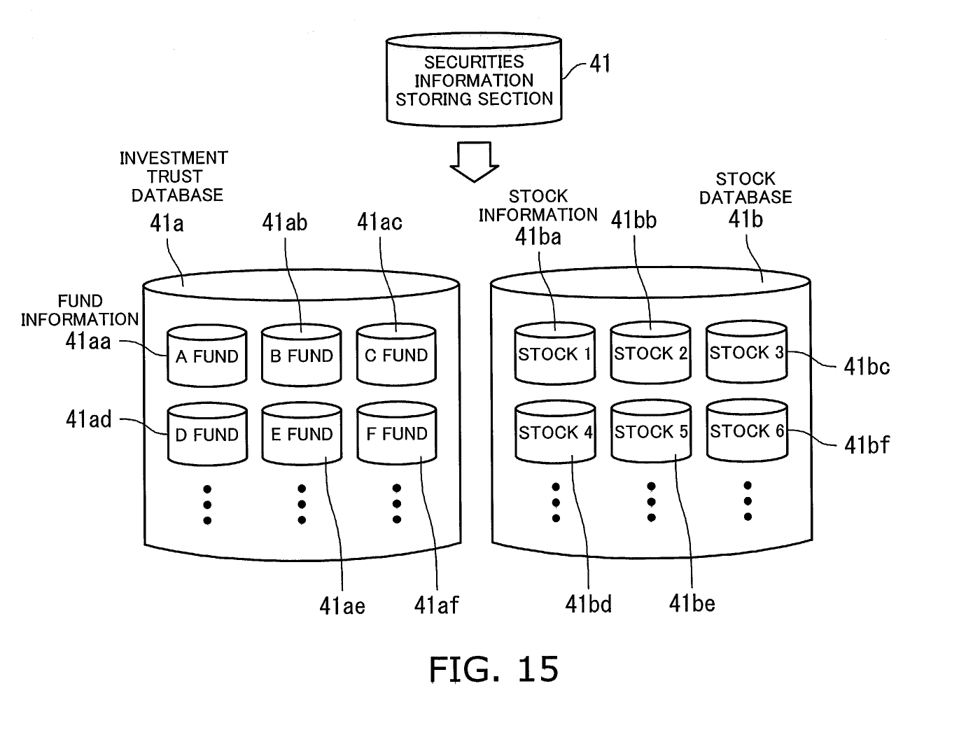

FIG. 15 is a schematic view showing the data structure of securities attribute information stored in the securities information storing section 41 shown in FIG. 14.

As shown in FIG. 15, the securities information storing section 41 includes, for example, an investment trust database 41a storing information regarding investment trusts and a stock database 41b storing information regarding stocks.

The investment trust database 41a stores, for example, fund information 41aa through 41af. The fund information 41aa is information regarding the investment trust “A fund,” the fund information 41ab is information regarding the investment trust “B fund,” and so on. The stock database 41b stores, for example, stock information 41ba through 41bf. The stock information 41ba is information regarding stock of “Stock 1,” the stock information 41bb is information regarding stock of “Stock 2,” and so on.

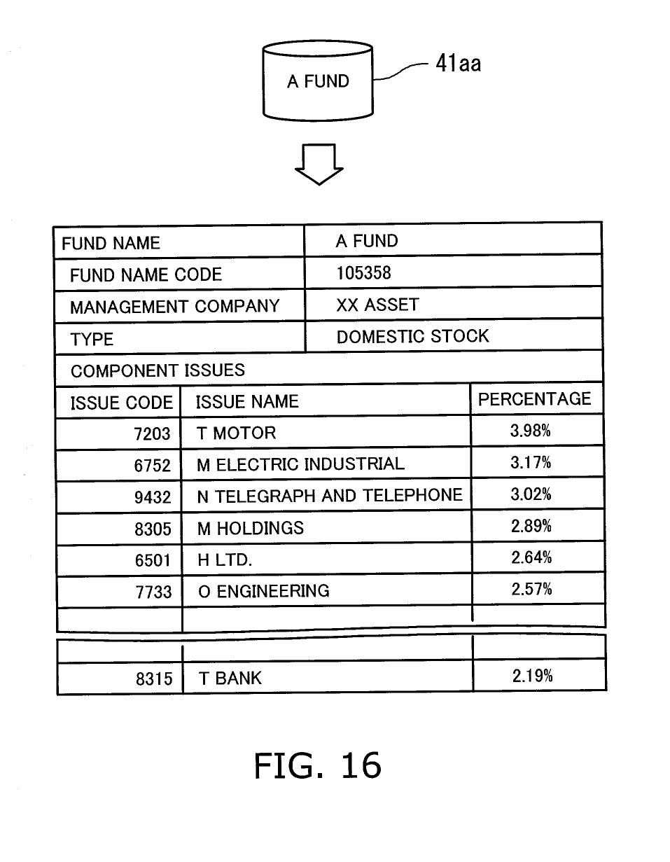

FIG. 16 is a schematic view showing the data structure of the fund information 41aa stored in the investment trust database 41a shown in FIG. 15.

As shown in FIG. 16, the fund information 41aa includes information regarding, for example, Fund Name being the name of a fund (investment trust), Fund Name Code being a code given to a fund name on a one-to-one basis, Management Company being a company to which the management of the fund is entrusted, Type being the type of the fund, and Component Issues being the names of stocks composing the fund. Component Issues includes information regarding, for example, Issue Code being a code given to the name of a stock composing the fund, Issue Name being the name of an issue, and Percentage being the component percentage of each issue in the fund.

In the case of the fund information 41aa regarding “A fund” shown in FIG. 16, Fund Name is “A fund,” Fund Name Code is “105358,” Management Company is “XX Asset,” and Type is “domestic stock.” Moreover, in this example, Component Issues shows the following. “A fund” is composed of “T Motor,” “M Electric Industrial,” “N Telegraph and Telephone,” “M Holdings,” “H Ltd.,” “O Engineering,” and “T Bank” stocks (shown by Issue Name); their issue codes are “7203,” “6752,” “9432,” “8305,” “6501,” “7733,” and “8315” respectively (shown by Issue Code); and their component percentages are “3.98%,” “3.17%,” “3.02%,” “2.89%,” “2.64%,” “2.57%,” and “2.19%” respectively (shown by Percentage).

In FIG. 16, only the data structure of the fund information 41aa is shown. However, the fund information other than it has the same structure as the fund information 41aa has and various pieces of information are set.

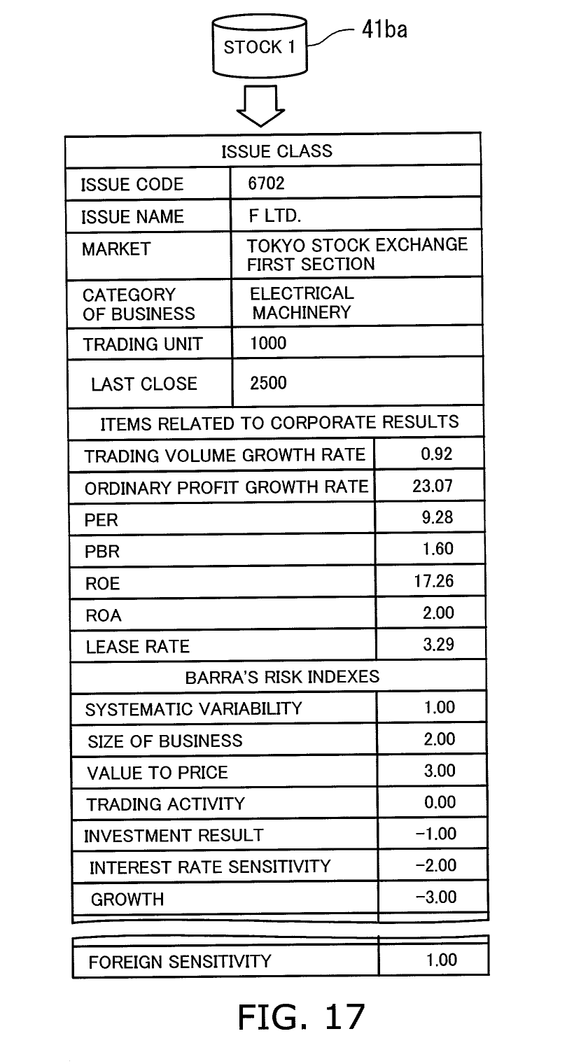

FIG. 17 is a schematic view showing the data structure of the stock information 41ba stored in the stock database 41b shown in FIG. 15.

As shown in FIG. 17, the stock information 41ba includes information regarding, for example, Issue Class which indicates the class of each issue, Items Related to Corporate Results which indicates the business results of a company corresponding to each issue, and Barra's Risk Indexes which indicate expected values for each issue.

Issue Class includes information regarding, for example, Issue Code being a code given to each issue, Issue Name being the name of each issue, Market which indicates the type of a market, Category of Business which indicates a category of business corresponding to each issue, Trading Unit which indicates a trading unit for each issue, and Last Close which indicates the closing quotation of the previous day for each issue.

Items Related to Corporate Results includes information regarding, for example, Trading Volume Growth Rate which indicates the growth rate of trading volume, Ordinary Profit Growth Rate which indicates the growth rate of ordinary profit, PER (price earnings ratio) calculated by dividing stock price by after-tax profit per share, PBR (price book-value ratio) calculated by dividing stock price by book value per share, ROE (return on equity) which indicates corporate profitability and which is calculated by dividing after-tax profit by stockholders' equity, ROA (return on asset) calculated by dividing corporate current income by total assets, and Margin Trading Ratio. Here, “Margin Trading Ratio” denotes the ratio of margin buying to margin selling of securities, which is calculated by dividing the balance of loans by the balance of loaned stocks in value terms. Barra's Risk Indexes includes information regarding, for example, Systematic Variability, Size of Business, Value to Price, Trading Activity, Investment Result, Interest Rate Sensitivity, Growth, and Foreign Sensitivity described above.

In the case of the stock information 41ba regarding the stock of Stock 1 shown in FIG. 17, Issue Code is “6702,” Issue Name is “F Ltd.,” Market is “Tokyo Stock Exchange First Section,” Category of Business is “Electrical Machinery,” Trading Unit is “1000,” and Last Close is “2500.” Moreover, Trading Volume Growth Rate is “0.92,” Ordinary Profit Growth Rate is “23.07,” PER is “9.28,” PBR is “1.60,” ROE is “17.26,” ROA is “2.00,” and Margin Trading Ratio is “3.29.” Systematic Variability is “1.00,” Size of Business is “2.00,” Value to Price is “3.00,” Trading Activity is “0.00,” Investment Result is “−1.00,” Interest Rate Sensitivity is “−2.00,” Growth is “−3.00,” and Foreign Sensitivity is “1.00.”

In FIG. 17, only the data structure of the stock information 41ba is shown. However, the stock information other than it includes the same information as the stock information 41ba includes.

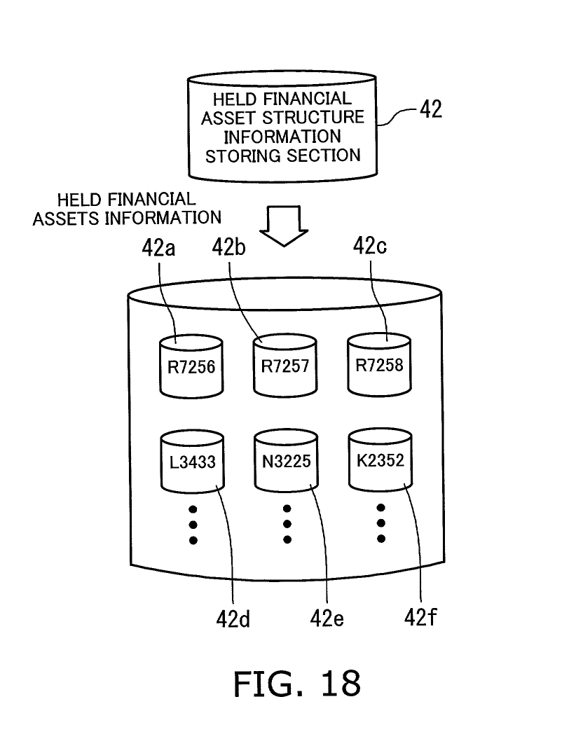

FIG. 18 is a schematic view showing the structure of held financial assets information 42a through 42f stored in the held financial asset structure information storing section 42 shown in FIG. 14.

As shown in FIG. 18, the held financial asset structure information storing section 42 stores, for example, the held financial assets information 42a through 42f, being information which indicates the structure of financial assets held by each investor.

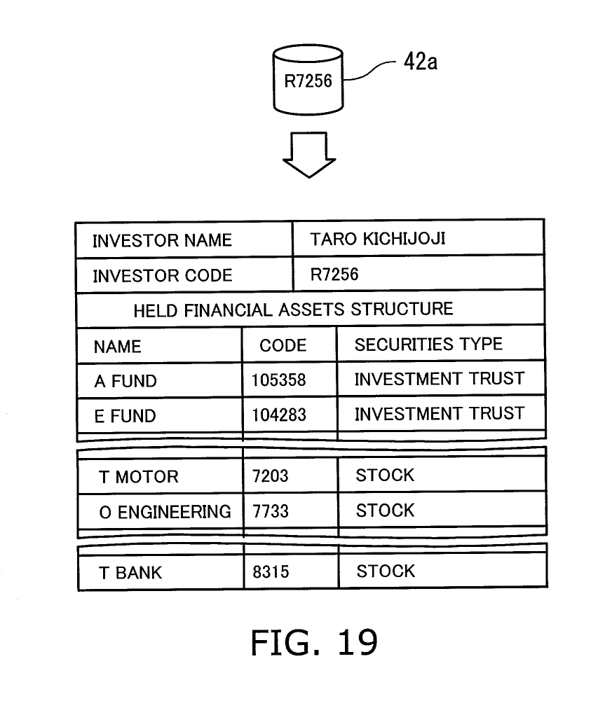

FIG. 19 is a schematic view showing the data structure of the held financial assets information 42a shown in FIG. 18.

As shown in FIG. 19, the held financial assets information 42a includes information regarding, for example, Investor Name which indicates the name of a person who makes an investment in financial assets, Investor Code being a code given to each investor, and Held Financial Assets Structure which indicates the structure of held financial assets. Held Financial Assets Structure includes information regarding, for example, Name which indicates the name of each of securities composing the held financial assets, Code being a code given to each of securities, and Securities Type which indicates the type of each of securities.

In the case of the held financial assets information 42a shown in FIG. 19, Investor Name is “Taro Kichijoji” and Investor Code is “R7256.” Held Financial Assets Structure, that is to say, Name, Code, and Securities Type show that these held financial assets are composed of “A Fund” with the code of “105358” (“investment trust”), “E Fund” with the code of “104283” (“investment trust”), “T Motor” with the code of “7203” (“stock”), “O Engineering” with the code of “7733” (“stock”), and “T Bank” with the code of “8315” (“stock”).

In FIG. 19, only the data structure of the held financial assets information 42a is shown. However, the held financial assets information other than it has the same structure as the held financial assets information 42a has and various pieces of information are set.

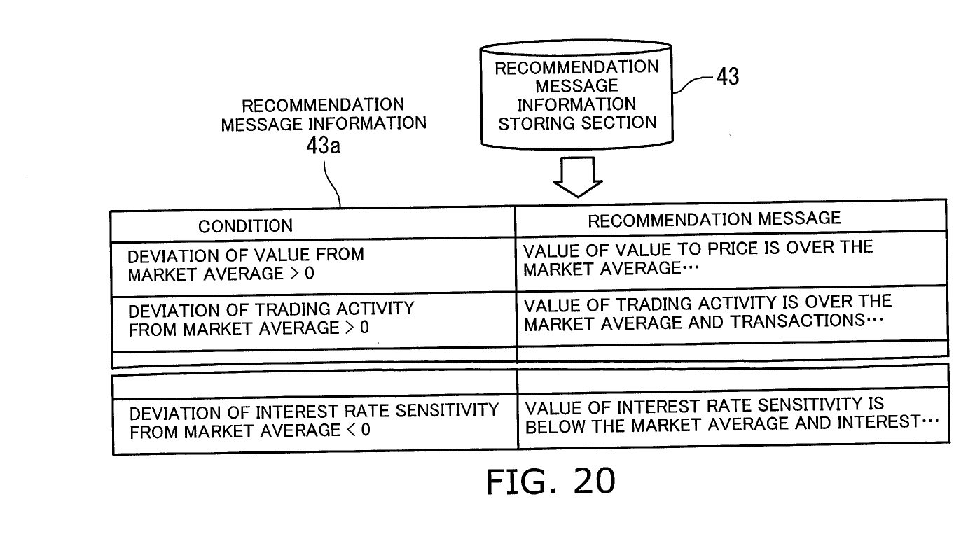

FIG. 20 is a view showing the data structure of recommendation message information 43a stored in the recommendation message information storing section 43 shown in FIG. 14.

As shown in FIG. 20, the recommendation message information 43a includes information regarding, for example, Condition which indicates a condition corresponding to each recommendation message and Recommendation Message which indicates the contents of recommendation messages.

In this example, “deviation of Value from the market average>0,” “deviation of Trading Activity from the market average>0,” and “deviation of Interest Rate Sensitivity from the market average<0” are shown as Condition. “Value of Value to Price is greater than the market average . . . , “Value of Trading Activity is greater than the market average and transactions . . . ,” and “Value of Interest Rate Sensitivity is smaller than the market average and interest . . . ” are shown as Recommendation Message corresponding to these conditions.

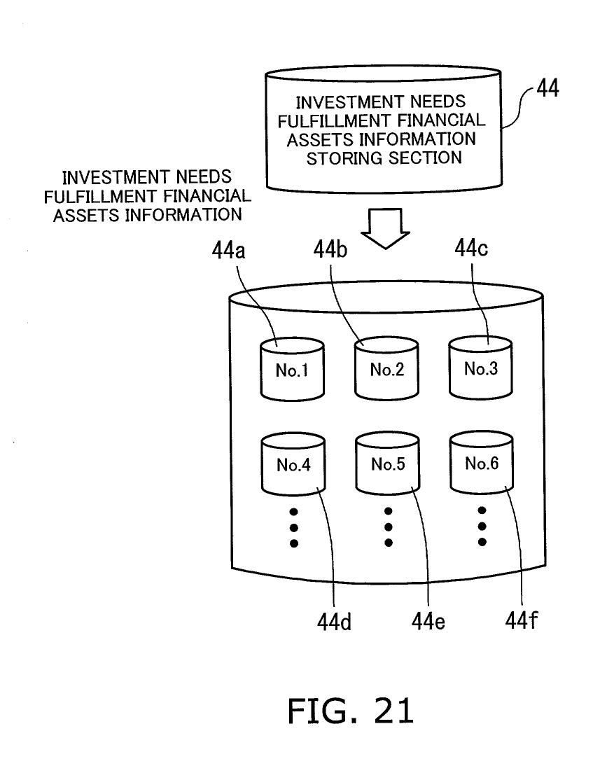

FIG. 21 is a schematic view showing the data structure of investment needs fulfillment financial assets information stored in the investment needs fulfillment financial assets information storing section 44 shown in FIG. 14.

As shown in FIG. 21, the investment needs fulfillment financial assets information storing section 44 stores, for example, investment needs fulfillment financial assets information 44a through 44f indicative of rebalanced financial assets which fulfill investment needs.

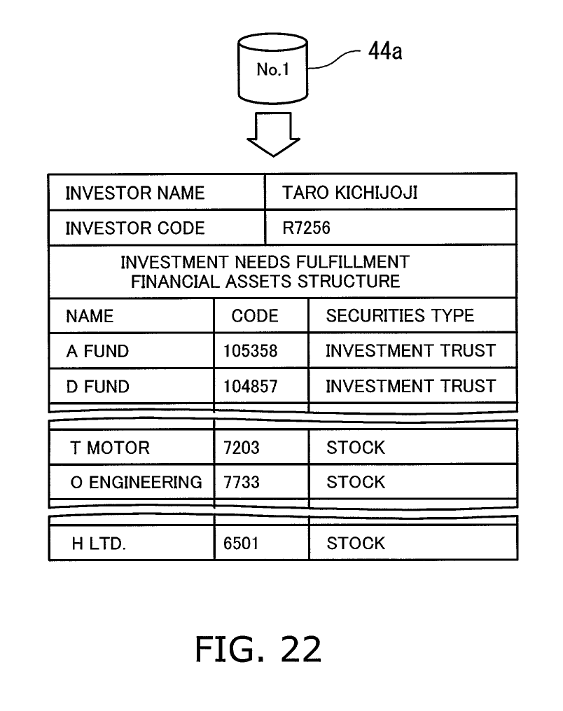

FIG. 22 is a schematic view showing the data structure of the investment needs fulfillment financial assets information 44a shown in FIG. 21.

As shown in FIG. 22, the investment needs fulfillment financial assets information 44a includes information regarding, for example, Investor Name which indicates the name of an investor in rebalanced financial assets, Investor Code being a code given to each investor, and Investment Needs Fulfillment Financial Assets Structure indicative of the structure of rebalanced financial assets which fulfill investment needs. Investment Needs Fulfillment Financial Assets Structure includes information regarding, for example, Name which indicates the name of each of securities composing the financial assets, Code being a code given to each of securities, and Securities Type which indicates the type of each of securities.

In the case of the investment needs fulfillment financial assets information 44a shown in FIG. 22, Investor Name is “Taro Kichijoji” and Investor Code is “R7256.” Investment Needs Fulfillment Financial Assets Structure, that is to say, Name, Code, and Securities Type show that these investment needs fulfillment financial assets are composed of “A Fund” with the code of “105358” (“investment trust”), “D Fund” with the code of “104857” (“investment trust”), “T Motor” with the code of “7203” (“stock”), “O Engineering” with the code of “7733” (“stock”), and “H Ltd.” with the code of “6501” (“stock”).

In FIG. 22, only the data structure of the investment needs fulfillment financial assets information 44a is shown. However, the investment needs fulfillment financial assets information other than it includes the same information as the investment needs fulfillment financial assets information 44a includes.

Now, processes performed by the asset management invitation unit 40 according to the second embodiment will be described.

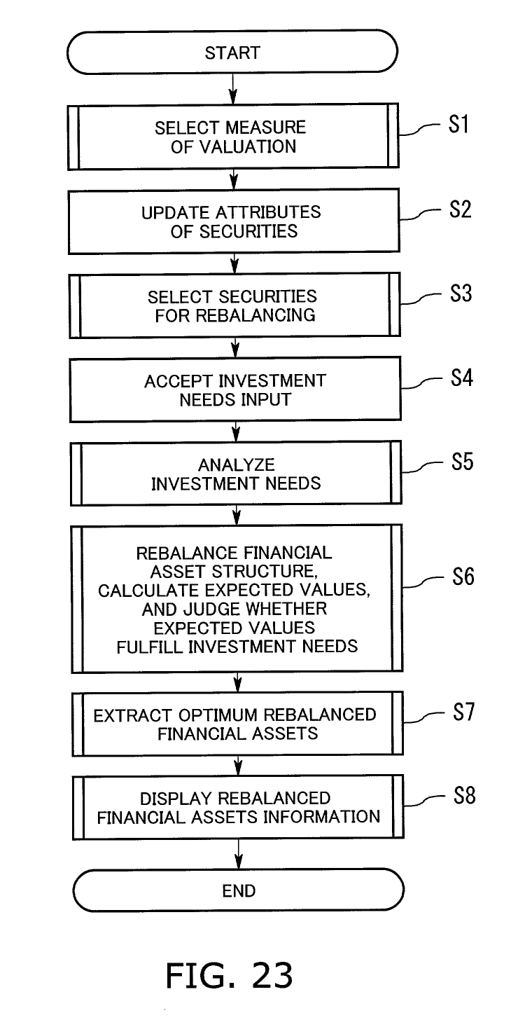

FIG. 23 is a flow chart for describing all the process performed by the asset management invitation unit according to the second embodiment. All the process performed by the asset management invitation unit 40 according to the second embodiment will now be described in compliance with this flow chart.

[Step S1] In this step, a measure of valuation will be selected on the basis of an investment climate. When a measure of valuation is selected in this step, first a user, such as the person in charge of a securities company, inputs investment climate information indicative of the latest investment climate with the investment climate information inputting section 45 shown in FIG. 14. The investment climate information input in this way is sent to the valuation measure selecting section 46. The valuation measure selecting section 46 selects a measure of valuation on the basis of the investment climate information sent from the investment climate information inputting section 45. In this process, a plurality of measures of valuation will be selected. The details of this process will be described later.

After measures of valuation are selected, step S2 will be performed.

[Step S2] In this step, the attributes of securities will be updated (securities attribute information updating step).

When the attributes of securities are updated in this step, first a user, such as the person in charge of a securities company, inputs market value information about each of securities (securities attribute market value valuation information), including the latest stock quotations and corporate results, with the securities attribute update information inputting section 47 shown in FIG. 14. The securities attribute market value valuation information input in this way is sent to the securities attribute information updating section 48. The securities attribute information updating section 48 updates information stored in the investment trust database 41a or stock database 41b stored in the securities information storing section 41 by the use of the securities attribute market value valuation information sent from the securities attribute update information inputting section 47. By updating information stored in the investment trust database 41a or stock database 41b in this way, the person in charge of a securities company, for example, can suggest the rebalancing of financial assets by the use of the latest securities attribute market values.

The process in this step may be performed on regular basis or with specified timing regardless of a series of processes described on the flow chart shown in FIG. 23. In addition, securities attribute market value valuation information may be input automatically.

After securities attribute information is updated, step S3 will be performed.

[Step S3] In this step, securities for rebalancing, being securities used for rebalancing financial assets, will be selected.

When securities for rebalancing are selected in this step, first an investor, for example, inputs securities selection information, being information necessary for specifying securities used for rebalancing financial assets, with the securities selection information inputting section 49 shown in FIG. 14. The securities selection information input in this way is sent to the securities selecting section 50. The securities selecting section 50 specifies securities used for rebalancing the financial assets and provides information indicative of the specified securities to the securities information storing section 41. The securities information storing section 41 stores information (flag information, for example) necessary for specifying the selected securities on the basis of the information supplied from the securities selecting section 50. The details of the process in this step will be described later.

After securities for rebalancing are selected, step S4 will be performed.

[Step S4] In this step, investment needs input will be accepted (investment needs information inputting step).

In this step, an investor, for example, inputs investment needs information, being information regarding his/her investment needs, with the investment needs information inputting section 51 shown in FIG. 14. Investment needs information input in this step is information, for example, generated on the basis of information input by the investor in the form of an answer to a questionnaire. By inputting investment needs information in the form of an answer to a questionnaire in this way, anyone can easily specify his investment needs. A concrete example of inputting investment needs information in the form of an answer to a questionnaire will be described later.

After investment needs are input, step S5 will be performed.

[Step S5] In this step, investment needs indicated in the investment needs information input in step S4 will be analyzed.

For example, the investment needs information inputting section 51 shown in FIG. 14 analyzes investment needs in this step. The investment needs information inputting section 51 obtains information regarding the plurality of measures of valuation selected in step S1 by the valuation measure selecting section 46 from it. Then the investment needs information inputting section 51 calculates the expected values of financial assets indicated in the input investment needs by the use of the plurality of measures of valuation indicated in the information. As a result, the expected values of the investment needs on the basis of the plurality of measures of valuation selected in step S1 will be calculated.

After the investment needs are analyzed, step S6 will be performed.

[Step S6] In this step, the financial asset structure rebalancing section 52 changes at least part of held financial assets indicated in held financial asset structure information stored in the held financial asset structure information storing section 42 to other securities (financial asset structure rebalancing step). Moreover, the rebalanced financial asset expected value calculating section 53 calculates the expected values of the rebalanced financial assets rebalanced in the financial asset structure rebalancing step on the basis of the plurality of measures of valuation by the use of securities attribute information stored in the securities information storing section 41 (rebalanced financial asset expected value calculating step).

Furthermore, the investment needs fulfillment judging section 54 judges whether the expected values of the rebalanced financial assets calculated in the rebalanced financial asset expected value calculating step fulfill the investment needs indicated in the investment needs information input in the investment needs information inputting step, that is to say, in step S4 (investment needs fulfillment judging step).

Information regarding investment needs fulfillment financial assets, being rebalanced financial assets judged in the investment needs fulfillment judging step to be correspondent to the investment needs is sent to the investment needs fulfillment financial assets information storing section 44 shown in FIG. 14. Information sent in this way will be stored in the investment needs fulfillment financial assets information storing section 44 as the investment needs fulfillment financial assets information 44a through 44f shown in FIGS. 21 and 22.

The details of these processes will be described later.

After the investment needs fulfillment financial assets information 44a through 44f is stored in the investment needs fulfillment financial assets information storing section 44 in this way, step S7, for example, will be performed.

[Step S7] In this step, the optimum rebalanced financial assets extracting section 55 extracts the optimum rebalanced financial assets, being rebalanced financial assets that fulfill the investment needs best, from among rebalanced financial assets judged in the investment needs fulfillment judging step to be correspondent to the investment needs from the investment needs fulfillment financial assets information storing section 44 (optimum rebalanced financial assets extracting step).

For example, a first radar chart indicative of an investor's investment needs indicated in the investment needs information input in the investment needs information inputting step (step S4) and second radar charts indicative of the respective expected values of the rebalanced financial assets calculated in the rebalanced financial asset expected value calculating step are compared.

In this case, a second radar chart with the highest degree of similarity in shape and size to the first radar chart is selected from among the second radar charts almost similar to the first radar chart. The rebalanced financial assets having the expected values indicated in that radar chart are extracted as optimum rebalanced financial assets (optimum rebalanced financial assets extracting step).

The details of this process will be described later.

After the optimum rebalanced financial assets are extracted, step S8, for example, will be performed.

[Step S8] In this step, the rebalanced financial assets information displaying section 56 shown in FIG. 14 displays visually the expected values of rebalanced financial assets, which were judged in the investment needs fulfillment judging step to be correspondent to the investment needs, by the use of a graph (rebalanced financial assets information displaying step). For example, the rebalanced financial assets information displaying section 56 visually displays the expected value of the optimum rebalanced financial assets extracted in the optimum rebalanced financial assets extracting step (step S7) by the use of a graph.

The details of the process in this step will be described later.

Now, the details of the process performed in step S1 in the flow chart shown in FIG. 23 will be described.

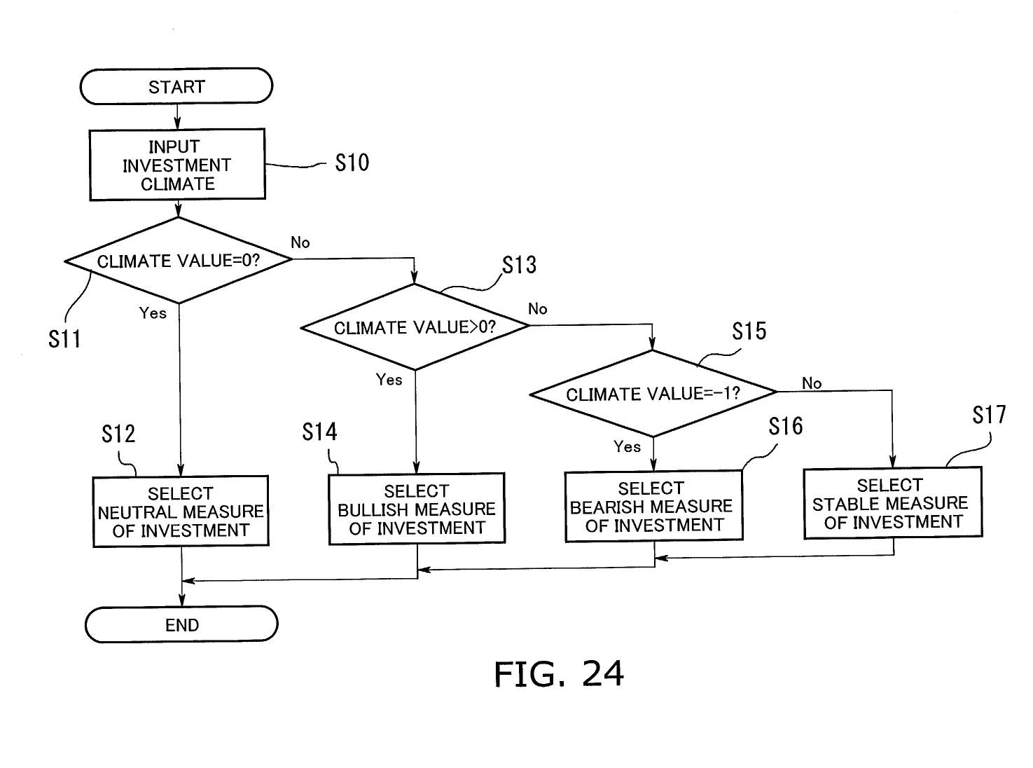

FIG. 24 is a flow chart for describing the details of the process performed in step S1 in the flow chart shown in FIG. 23. The details of the process performed in step S1 in the flow chart shown in FIG. 23 will now be described in compliance with this flow chart.

[Step S10] In this step, an investment climate will be input.

For example, an investor inputs investment climate information, being information indicative of an investment climate, with the investment climate information inputting section 45 shown in FIG. 14. This investment climate information can be, for example, a climate value, being a numeric value indicative of an investment climate. For example, it is assumed that a state in which an investment climate is best, a state in which an investment climate is good, a state in which an investment climate is neutral, a state in which an investment climate is poor, and a state in which an investment climate is poorest are “upturn,” “bullish,” “neutral,” “bearish,” and “downturn” respectively and that climate values indicative of the investment climates “upturn,” “bullish,” “neutral,” “bearish,” and “downturn” are defined as “2,” “1,” “0,” “−1,” and “−2” respectively. By inputting these climate values as investment climate information with the investment climate information inputting section 45, the inputting of an investment climate in this step will be performed.

A climate value input in this way is sent to the valuation measure selecting section 46 and step S11 will be performed.

[Step S11] In this step, the valuation measure selecting section 46 judges whether or not the climate value indicative of an investment climate, which was input in step S10, is “0.” If the climate value indicative of an investment climate, which was input in step S10, is “0,” then step S12 will be performed. If the climate value indicative of an investment climate, which was input in step S10, is not “0,” then step S13 will be performed.

[Step S12] In this step, the valuation measure selecting section 46 selects a neutral measure of investment as a measure of valuation.

[Step S13] In this step, the valuation measure selecting section 46 judges whether or not the climate value indicative of an investment climate, which was input in step S10, is greater than “0.” If the climate value indicative of an investment climate, which was input in step S10, is greater than “0,” then step S14 will be performed. If the climate value indicative of an investment climate, which was input in step S10, is not greater than “0,” then step S15 will be performed.

[Step S14] In this step, the valuation measure selecting section 46 selects a bullish measure of investment as a measure of valuation.

[Step S15] In this step, the valuation measure selecting section 46 judges whether or not the climate value indicative of an investment climate, which was input in step S10, is “−1.” If the climate value indicative of an investment climate, which was input in step S10, is “−1,” then step S16 will be performed. If the climate value indicative of an investment climate, which was input in step S10, is not “−1,” then step S17 will be performed.

[Step S16] In this step, the valuation measure selecting section 46 selects a bearish measure of investment as a measure of valuation.

[Step S17] In this step, the valuation measure selecting section 46 selects a stable measure of investment as a measure of valuation.

Now, the details of the process performed in step S3 in the flow chart shown in FIG. 23 will be described.

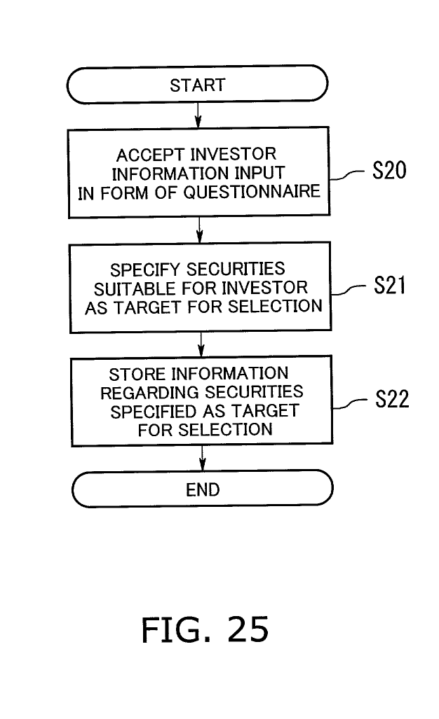

FIG. 25 is a flow chart for describing the details of the process performed in step S3 in the flow chart shown in FIG. 23. The details of the process performed in step S3 in the flow chart shown in FIG. 23 will now be described in compliance with this flow chart.

[Step S20] In this step, the securities selection information inputting section 49 shown in FIG. 14 accepts input investor information (corresponding to securities selection information), which indicates an investor's demand regarding financial asset management, in the form of a questionnaire.

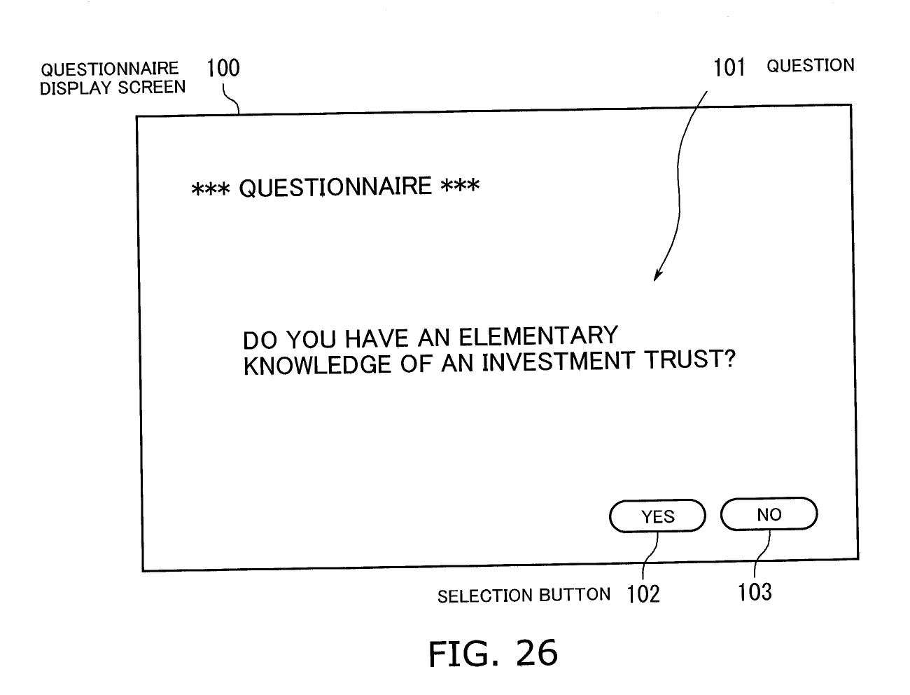

FIG. 26 is a view showing the structure of a questionnaire display screen 100 which appears on the securities selection information inputting section 49 in the case of inputting such investor information.

As shown in FIG. 26, a question 101, such as “Do you have an elementary knowledge of an investment trust?” and selection buttons 102 and 103 used for answering the displayed question 101 are displayed on the questionnaire display screen 100.

An investor, for example, reads the question 101 displayed on the questionnaire display screen 100 and inputs an answer to the question 101 by, for example, clicking on the selection button 102 or 103 by the use of a technique based on a graphical user interface (GUI). The contents of an answer input in this way will be reflected in the selection of the next question 101 that will be displayed on the securities selection information inputting section 49.

On the questionnaire display screens 100, different questions 101 are displayed in turn in this way and an answer to each of the questions 101 is accepted via the selection button 102 or 103. When answers to a predetermined number of questions 101 are given, this questionnaire terminates and the results of the questionnaire will be displayed on the securities selection information inputting section 49.

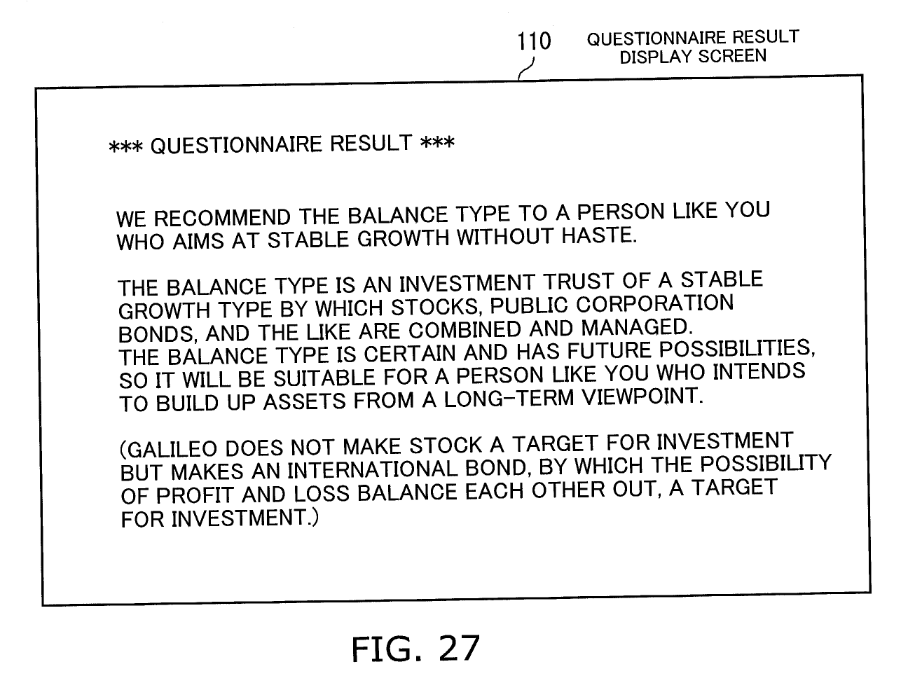

FIG. 27 is a view showing the structure of a questionnaire result display screen 110 which indicates the results of a questionnaire displayed in this way.

As shown in FIG. 27, questionnaire results, for example, specified on the basis of the contents of answers to the above questionnaire will be displayed on the questionnaire result display screen 110. In this example, the message “We recommend the balance type to a person like you who aims at stable growth without haste.” is displayed. This message means that an investment trust of the “balance type” is the most suitable for, for example, an investor who answered the questionnaire.

After the questionnaire result display screen 110 is displayed, a schooling screen for setting more detailed conditions in the same form of a questionnaire will be displayed on the securities selection information inputting section 49.

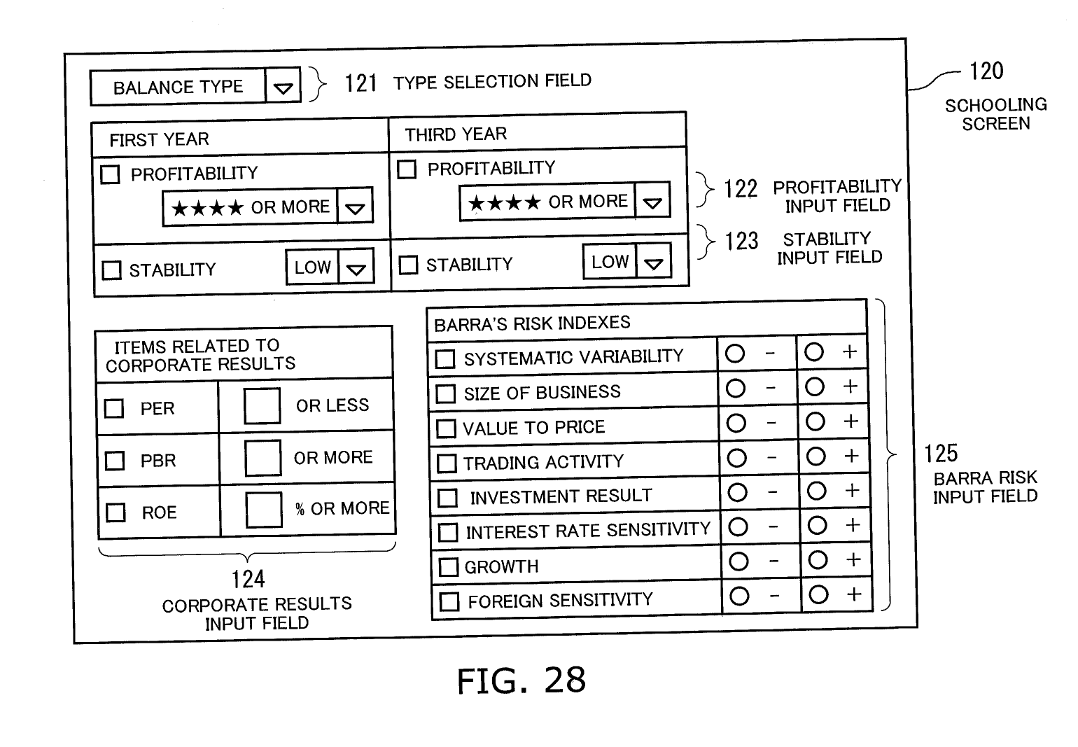

FIG. 28 is a view showing the structure of a schooling screen 120 displayed in this way.

As shown in FIG. 28, the schooling screen 120 consists of, for example, a type selection field 121 used for selecting the type of securities, a profitability input field 122 used for inputting profitability which an investor looks for from the selected securities, a stability input field 123 used for inputting stability which the investor looks for from the selected securities, a corporate results input field 124 used for inputting a request from, for example, the investor regarding the business results of a company to be invested in, and a Barra risk input field 125 used for inputting the expected values (Barra risks), such as “Systematic Variability,” of securities.

An investor, for example, reads the contents of the schooling screen 120 and inputs data in the type selection field 121, profitability input field 122, stability input field 123, corporate results input field 124, and Barra risk input field 125 by a GUI technique. An investor, for example, can input data in the type selection field 121 with reference to contents displayed on, for example, the above questionnaire result display screen 110.

Data (corresponding to securities selection information) input in this way is sent to the securities selecting section 50 and the next step S21 shown in FIG. 25 will be performed.

[Step S21] In this step, securities suitable for the investor will be specified as a target for selection on the basis of the securities selection information input in step S20.

In this step, for example, the securities selecting section 50 extracts securities corresponding to the securities selection information input in step S20 from information stored in the securities information storing section 41. By doing so, securities will be specified. The contents of the securities specified in this way will be displayed in the form of, for example, a list.

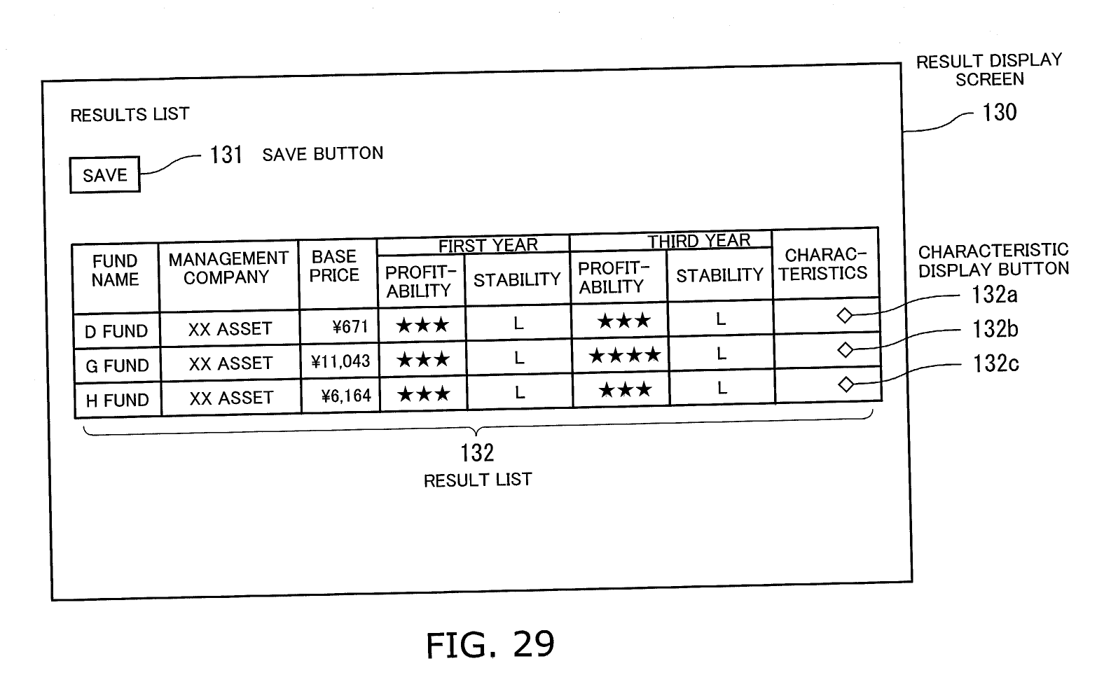

FIG. 29 is a view showing the structure of a result display screen 130 on which the contents of securities specified in this way are displayed in the form of a list.

As shown in FIG. 29, the result display screen 130 consists of, for example, a result list 132 in which the contents of securities specified are indicated in the form of a list and a Save button 131. By clicking on the Save button 131, the contents of the securities specified in this way will be saved.

The result list 132 includes, for example, Fund Name field which indicates the contents of the specified securities, Management Company field, Base Price field, first year Profitability and Stability fields, third year Profitability and Stability fields, and Characteristics field in which Characteristic Display buttons 132a through 132c are located. By clicking on the Characteristic Display buttons 132a through 132c, the details of the characteristics of the specified securities will be displayed. In this example, “D fund,” G fund,” and “H fund,” “XX Asset,” “¥671,” “¥11,043,” and “¥6,164,” “★★★,” “L,” “★★★,” “★★★★,” and “★★★,” and “L” are displayed in the Fund Name field, Management Company field, Base Price field, first year Profitability field, first year Stability field, third year Profitability field, and third year Stability field respectively.

An investor, for example, reads the result list 132 displayed in this way and displays the contents of the characteristics of each of securities by clicking on the Characteristic Display buttons 132a through 132c. The investor judges by reading the contents of the characteristics of each of the securities whether the specified securities are suitable for securities for rebalancing. If he/she judges that the specified securities are suitable for securities for rebalancing, then he/she clicks on the Save button 131.

When clicking is performed on the Save button 131, the process in step S22 shown in FIG. 25 will be performed.

[Step S22] In this step, the securities selecting section 50 stores information regarding the securities specified in step S21 as a target for selection (securities for rebalancing) in the securities information storing section 41.

Now, a concrete example of investment needs information input in the form of a questionnaire in the process in step S4 in the flow chart shown in FIG. 23 will be described.

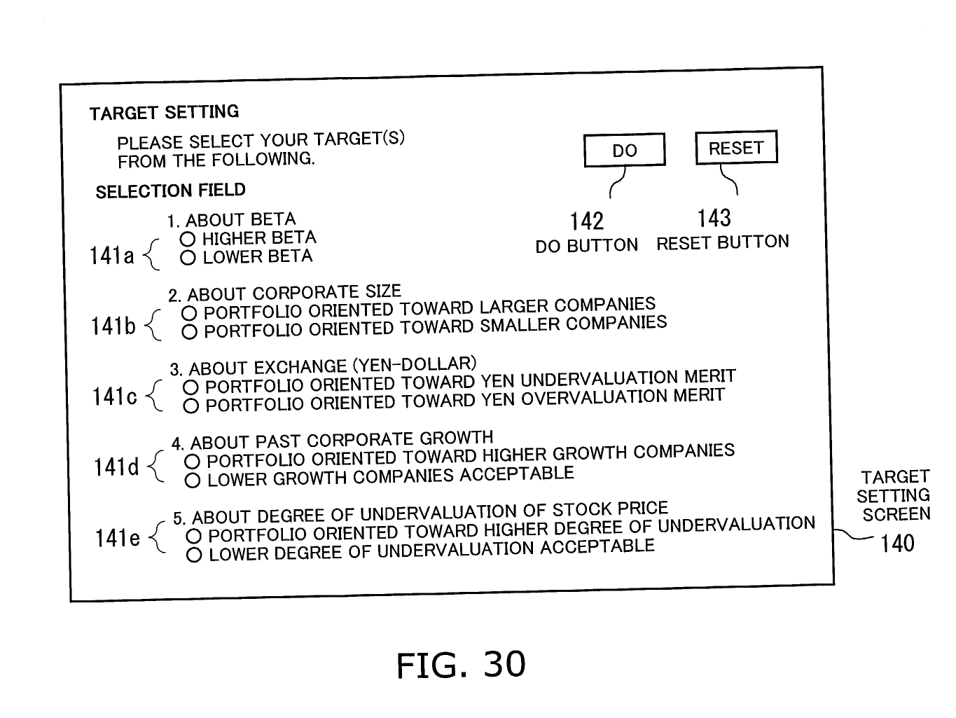

FIG. 30 is a view showing a target setting screen 140 which appears in the case of inputting investment needs in step S4 in the flow chart shown in FIG. 23.

As shown in FIG. 30, a plurality of questionnaire items necessary for target setting for defining investment needs and selection fields 141a through 141e in which answers concerning the questionnaire items are input by a GUI technique are displayed on the target setting screen 140.

In this example, “About Beta,” “About Size of Business,” “About Exchange (Yen-Dollar),” “About Past Busines Growth,” and “About Degree of Undervaluation of Stock Price” are displayed as questionnaire items. The selection fields 141a through 141e are associated with these questionnaire items.

In the selection field 141a, “Higher beta” and “Lower beta” are displayed. In the selection field 141b, “Portfolio oriented toward larger companies” and “Portfolio oriented toward smaller companies” are displayed. In the selection field 141c, “Portfolio oriented toward yen undervaluation merit” and “Portfolio oriented toward yen overvaluation merit” are displayed. In the selection field 141d, “Portfolio oriented toward higher growth companies” and “Lower growth companies acceptable” are displayed. In the selection field 141e, “Portfolio oriented toward higher degree of undervaluation” and “Lower degree of undervaluation acceptable” are displayed.

On the target setting screen 140, a Do button 142 which an investor, for example, clicks to confirm the contents of input into the selection fields 141a through 141e and a Reset button 143 which an investor, for example, clicks to reset the contents of input into the selection fields 141a through 141e are also displayed. An investor, for example, looks at the target setting screen 140, inputs information in the selection fields 141a through 141e, and clicks on the Do button 142. By doing so, an investor, for example, can set his/her target(s) in the form of a questionnaire. As shown in the description of step S4, for example, information input in this way is used for generating investment needs information and investment needs information generated in this way is sent to the investment needs fulfillment judging section 54 shown in FIG. 14.

Now, the details of the process performed in step S6 in the flow chart shown in FIG. 23 will be described.

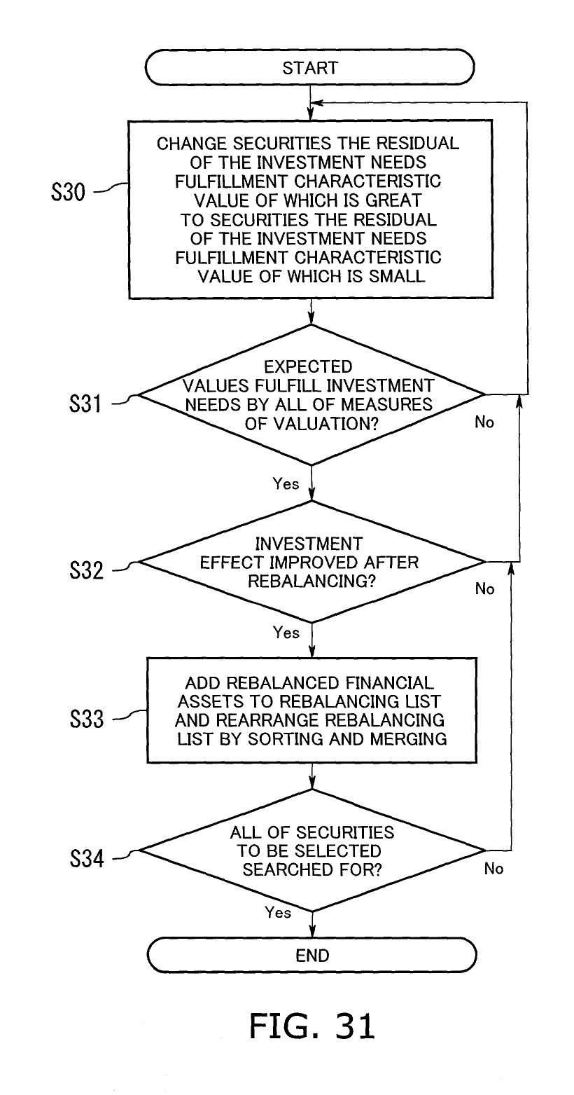

FIG. 31 is a flow chart for describing the details of the process performed in step S6 in the flow chart shown in FIG. 23. The details of the process performed in step S6 in the flow chart shown in FIG. 23 will now be described in compliance with this flow chart.

[Step S30] In this step, the financial asset structure rebalancing section 52 shown in FIG. 14 changes securities in financial assets held by an investor the residual of the investment needs fulfillment characteristic value of which is great to securities the residual of the investment needs fulfillment characteristic value of which is small.

In this case, first the financial asset structure rebalancing section 52, for example, extracts information (held financial assets information) regarding financial assets to be rebalanced for the purpose of suggesting financial asset management to an investor from the held financial asset structure information storing section 42. Then the financial asset structure rebalancing section 52 changes at least part of securities composing held financial asset indicated in the extracted held financial assets information to securities stored in the securities information storing section 41. These securities for rebalancing must be selected in step S3 in the flow chart shown in FIG. 23 and information to that effect must be stored in the securities information storing section 41.

After at least part of the securities composing the held financial asset are rebalanced, the rebalanced financial asset expected value calculating section 53 shown in FIG. 14 calculates the expected values of the held financial assets (rebalanced financial assets) in which at least part of the securities were rebalanced.

In this case, first the rebalanced financial asset expected value calculating section 53, for example, obtains information regarding the rebalanced financial assets (including securities attribute information regarding the securities composing the rebalanced financial assets) from the financial asset structure rebalancing section 52 and obtains information regarding the measures of valuation selected in step S1 in the flow chart shown in FIG. 23 from the valuation measure selecting section 46. After obtaining this information, the rebalanced financial asset expected value calculating section 53 calculates the expected values of the rebalanced financial assets indicated in the information obtained from the financial asset structure rebalancing section 52 on the basis of the measures of valuation indicated in the information obtained from the valuation measure selecting section 46.

After the expected values of the rebalanced financial assets are calculated in this way, step S31 will be performed.

[Step S31] In this step, the investment needs fulfillment judging section 54 judges whether the expected values of the rebalanced financial assets calculated in step S30 fulfill investment needs by all of the measures of valuation selected in step S1 in the flow chart shown in FIG. 23.

In this case, first the investment needs fulfillment judging section 54 obtains information regarding the expected values of the rebalanced financial assets from the rebalanced financial asset expected value calculating section 53 and obtains information regarding the expected values (calculated in step S5) of financial assets indicated in investment needs from the investment needs information inputting section 51. The expected values of the rebalanced financial assets and the expected values of financial assets indicated in investment needs obtained from the investment needs fulfillment judging section 54 were calculated by the same measures of valuation selected in step S1 in the flow chart shown in FIG. 23.

The investment needs fulfillment judging section 54 compares the expected values of the rebalanced financial assets indicated in the information and the expected values of financial assets indicated in the investment needs. The investment needs fulfillment judging section 54 judges from the result of the comparison whether or not the expected values of the rebalanced financial assets fulfill the expected values of financial assets indicated in the investment needs (whether the expected values of the rebalanced financial assets fulfill the investment needs) by all of the measures of valuation selected in step S1 in the flow chart shown in FIG. 23. If the investment needs fulfillment judging section 54 judges that the expected values of the rebalanced financial assets fulfill the investment needs, then step S32 will be performed. If the investment needs fulfillment judging section 54 judges that the expected values of the rebalanced financial assets do not fulfill the investment needs, then step S30 will be performed.

[Step S32] In this step, the investment needs fulfillment judging section 54 synthetically judges whether or not the rebalanced financial assets improve the investment effect more than the held financial assets.

To be concrete, the investment needs fulfillment judging section 54 judges whether rebalancing part of the securities composing the held financial assets has caused other side effects (rebalancing securities with the aim of improving the investment effect has lowered Trading Activity, for example).

If the investment needs fulfillment judging section 54 judges that the investment effect has been improved, then the investment needs fulfillment judging section 54 judges information indicative of those rebalanced financial assets to be investment needs fulfillment financial assets and proceeds to step S33. If the investment needs fulfillment judging section 54 judges that the investment effect has not been improved, then step S30 will be performed.

[Step S33] In this step, the investment needs fulfillment judging section 54 adds the rebalanced financial assets it judged in step S32 to be investment needs fulfillment financial assets to a rebalancing list consisting of the investment needs fulfillment financial assets information 44a through 44f stored in the investment needs fulfillment financial assets information storing section 44 as new investment needs fulfillment financial assets information and rearranges this rebalancing list by sorting and merging.

The rearranged rebalancing list is stored in the investment needs fulfillment financial assets information storing section 44, then step S34, for example, will be performed.

[Step S34] In this step, the financial asset structure rebalancing section 52 judges whether all of the securities to be selected (securities selected as securities for rebalancing in step S3 in the flow chart shown in FIG. 23) from among securities indicated in information stored in the securities information storing section 41 were used for rebalancing the held financial assets and whether the processes in step S31 through S33 were performed on all of the generated rebalanced financial assets (whether all of the securities to be selected were searched for).

If the financial asset structure rebalancing section 52 judges that all of the securities to be selected were searched for, then the process will terminate. If the financial asset structure rebalancing section 52 judges that not all of the securities to be selected were searched for, then step S30 will be performed.

Now, a concrete example of the process performed in step S6 in the flow chart shown in FIG. 23 will be described.

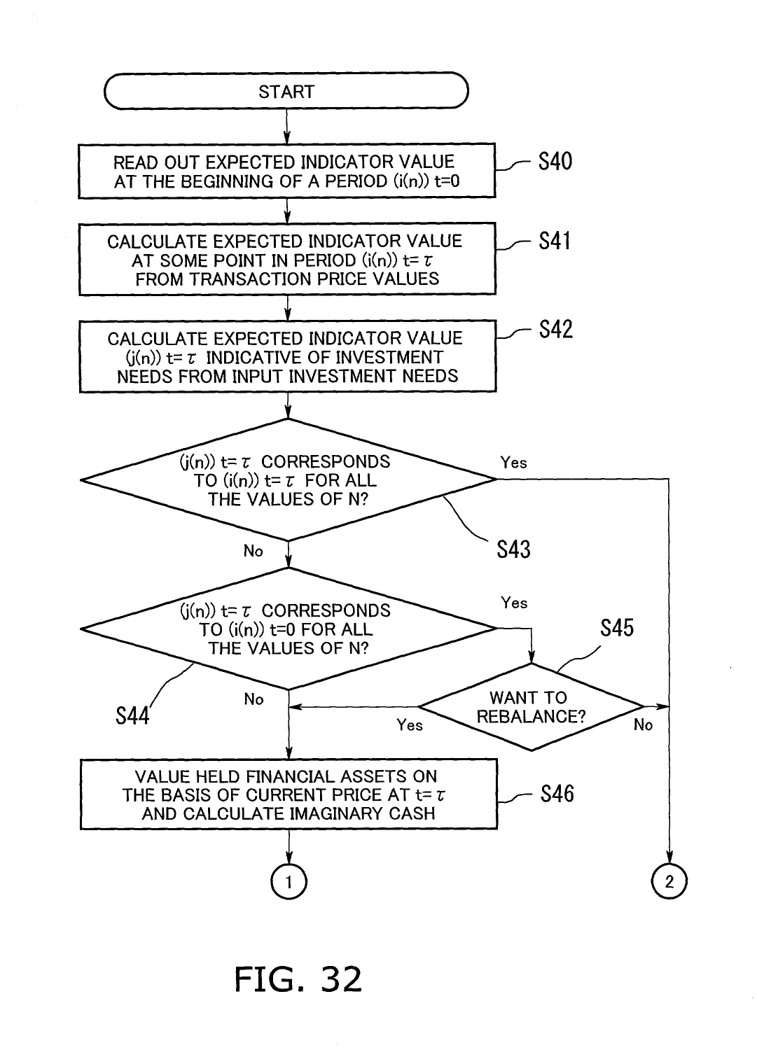

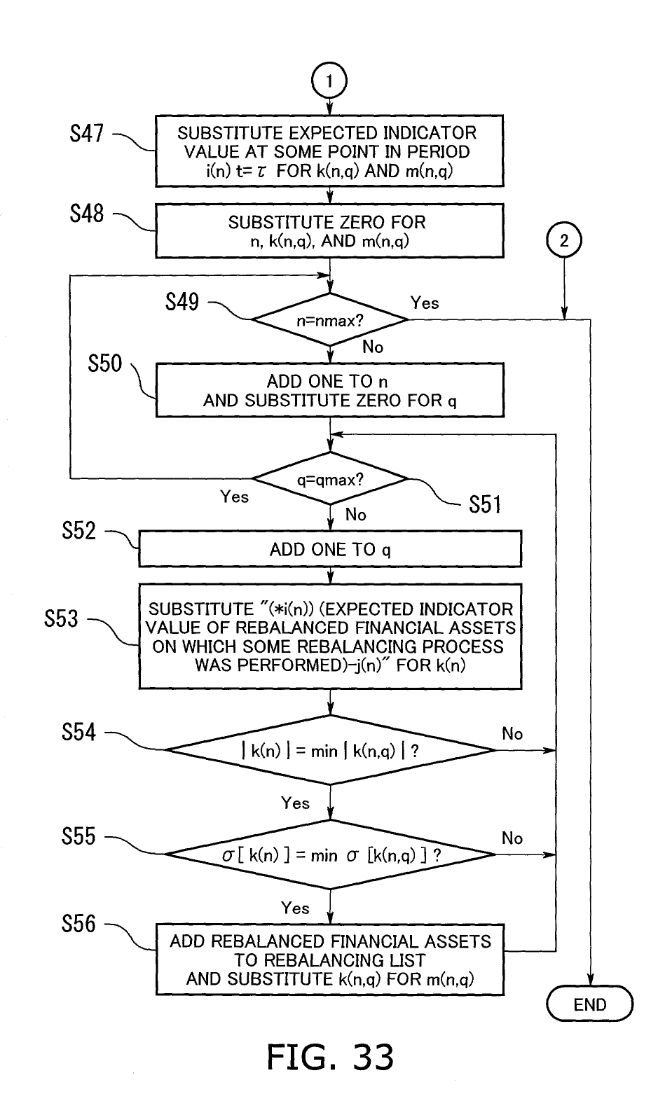

FIGS. 32 and 33 are flow charts for describing a concrete example of the process performed in step S6 in the flow chart shown in FIG. 23. A concrete example of the process performed in step S6 in the flow chart shown in FIG. 23 will now be described in compliance with these flow charts.

[Step S40] In this step, the rebalanced financial asset expected value calculating section 53 reads out the expected indicator value at the beginning of a period “(i(n)) t=0” of the held financial assets.

An expected indicator value is an expected value by one measure of valuation included in all of the expected values. For example, an expected indicator value is a numeric value which indicates an expected value by the measure of valuation “Size of Business.” “n” means a number (indicator number) given to each measure of valuation. If there are, for example, eight measures of valuation, n is a number between one and eight. “t” indicates a time series. t=0 means the beginning of a period and t=1 means the end of a period.

[Step S41] In this step, the rebalanced financial asset expected value calculating section 53 calculates an expected indicator value at some point in the period “(i(n)) t=τ” from transaction price values. t=τ means some point in a period (0≦τ≦1).

[Step S42] In this step, the investment needs information inputting section 51 calculates an expected indicator value “(j(n)) t=τ” indicative of investment needs indicated in input investment needs information from the investment needs.

[Step S43] In this step, the investment needs fulfillment judging section 54 judges whether the expected indicator value “(j(n)) t=τ” calculated in step S42 corresponds to the expected indicator value “(i(n)) t=τ” calculated in step S41 by all of the measures of valuation (for all the values of n).

If the investment needs fulfillment judging section 54 judges that the expected indicator value “(j (n)) t=τ” corresponds to the expected indicator value “(i(n)) t=τ,” then the process terminates. If the investment needs fulfillment judging section 54 judges that the expected indicator value “(j (n)) t=τ” does not correspond to the expected indicator value “(i(n)) t=τ” by at least one of the measures of valuation, then step S44 will be performed.

[Step S44] In this step, the investment needs fulfillment judging section 54 judges whether the expected indicator value “(j(n)) t=τ” calculated in step S42 corresponds to the expected indicator value “(i(n)) t=0” calculated in step S40 by all of the measures of valuation (for all the values of n). If the investment needs fulfillment judging section 54 judges that the expected indicator value “(j(n)) t=τ” corresponds to the expected indicator value “(i(n)) t=0,” then step S45 will be performed. If the investment needs fulfillment judging section 54 judges that the expected indicator value “(j(n)) t=τ” does not correspond to the expected indicator value “(i(n)) t=0” by at least one of the measures of valuation, then step S46 will be performed.

[Step S45] In this step, the investment needs fulfillment judging section 54 judges whether the investor wants to rebalance the held financial assets. This judgment will be made on the basis of, for example, information which was input by the investor and which indicates whether he/she wants to rebalance the held financial assets.

If the investment needs fulfillment judging section 54 judges that the investor wants to rebalance the held financial assets, then step S46 will be performed. If the investment needs fulfillment judging section 54 judges that the investor does not want to rebalance the held financial assets, then the process terminates.

[Step S46] In this step, the investment needs fulfillment judging section 54 values the held financial assets on the basis of the current price at t=τ (at some point in the period) and calculates imaginary cash according to the valuation. For example, the held financial assets will be rebalanced so that the amount of this imaginary cash will not be exceeded.

[Step S47] In this step, the investment needs fulfillment judging section 54 substitutes the expected indicator value at some point in the period “(i(n)) t=τ” for k(n,q) and m(n,q).

“q” is, for example, a number (unit asset number) given to securities, such as an investment trust and stock, added to part of the financial assets held by the investor. For example, if part of the held financial assets are changed to the securities the unit asset number q is given to, k(n,q) means the difference between the expected indicator value of the rebalanced financial assets corresponding to indicator number n and the expected indicator value of the investment needs corresponding to indicator number n. m(n,q) means a set of “k(n,q)” for the rebalanced financial assets judged to be correspondent to the investment needs.

[Step S48] In this step, the investment needs fulfillment judging section 54 substitutes zero for n, k(n,q), and m(n,q).

[Step S49] In this step, the investment needs fulfillment judging section 54 judges whether n=nmax.

nmax is the greatest value of n, that is to say, the greatest number given to a measure of valuation. If there are, for example, eight measures of valuation, then nmax is eight.

If the investment needs fulfillment judging section 54 judges that n=nmax, the process terminates. If the investment needs fulfillment judging section 54 judges that n does not equal nmax, then step S50 will be performed.

[Step S50] In this step, the investment needs fulfillment judging section 54 adds one to n and substitutes zero for q.

[Step S51] In this step, the investment needs fulfillment judging section 54 judges whether q=qmax.

qmax is the greatest unit asset number. If there are, for example, hundred securities used for rebalancing, then qmqx is hundred.

If the investment needs fulfillment judging section 54 judges that q=qmax, then step S49 will be performed. If the investment needs fulfillment judging section 54 judges that q does not equal qmax, then step S52 will be performed.

[Step S52] In this step, the investment needs fulfillment judging section 54 adds one to q.

[Step S53] In this step, the investment needs fulfillment judging section 54 substitutes “(*i(n)) (expected indicator value of rebalanced financial assets on which some rebalancing process was performed)−j(n)” for k(n).

As a result, k(n) will indicate the difference between the expected indicator value corresponding to indicator number n of rebalanced financial assets which were created by changing part of the held financial assets to investment trusts etc. selected freely and the expected indicator value corresponding to indicator number n of the investment needs.

[Step S54] In this step, the investment needs fulfillment judging section 54 judges whether the absolute value of the k(n) calculated in step S53 is the smallest of a set of the absolute values of all the k(n,q).

If the investment needs fulfillment judging section 54 judges that the absolute value of the k(n) calculated in step S53 is the smallest of a set of the absolute values of all the k(n,q), then step S55 will be performed. If the investment needs fulfillment judging section 54 judges that the absolute value of the k(n) calculated in step S53 is not the smallest of a set of the absolute values of all the k(n,q), then step S51 will be performed.

[Step S55] In this step, the investment needs fulfillment judging section 54 judges whether the standard deviation σ of the k(n) calculated in step S53 is the smallest of a set of the absolute values of the standard deviations σ of all the k(n,q).

If the investment needs fulfillment judging section 54 judges that the standard deviation σ of the k(n) calculated in step S53 is the smallest of a set of the absolute values of the standard deviations σ of all the k(n,q), then step S56 will be performed. If the investment needs fulfillment judging section 54 judges that the standard deviation σ of the k(n) calculated in step S53 is not the smallest of a set of the absolute values of the standard deviations σ of all the k(n,q), then step S51 will be performed.

[Step S56] In this step, the investment needs fulfillment judging section 54 adds the rebalanced financial assets to the rebalancing list stored in the investment needs fulfillment financial assets information storing section 44 (stores the rebalanced financial assets in the rebalancing list as a piece of investment needs fulfillment financial assets information) and substitutes k(n,q) for m(n,q).

Now, the details of the process performed in step S7 in the flow chart shown in FIG. 23 will be described.

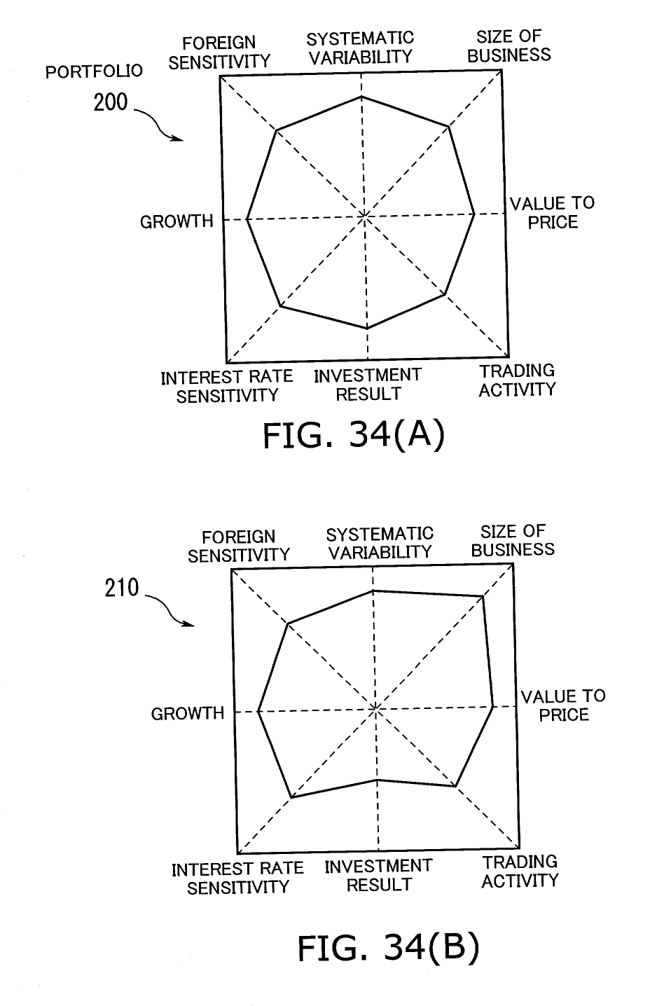

FIG. 34 is a view showing a portfolio in which the expected values of financial assets held by an investor are indicated with a radar chart. FIG. 34(A) is a view showing a portfolio 200 in which the expected values at the beginning of a period of held financial assets are indicated with a radar chart and FIG. 34(B) is a view showing a portfolio 210 in which the expected values at some point in the period (present valuation values) of the held financial assets are indicated with a radar chart.

As shown in FIGS. 34(A) and 34(B), in this example, Systematic Variability, Size of Business, Value to Price, Trading Activity, Investment Result, Interest Rate Sensitivity, Growth, and Foreign Sensitivity are selected as measures of valuation and an expected value corresponding to each selected measure is indicated on the radar chart. As shown in the portfolios 200 and 210, in this example, the expected value of the held financial assets corresponding to Investment Result has lowered, but, on the other hand, the expected value of the held financial assets corresponding to Size of Business has risen. This is caused by a change in the market from the beginning of the period to some point in the period.

It is assumed that the investor wants to rebalance his/her financial assets in order to equalize the portfolio 210 of the held financial assets at some point in the period with the portfolio 200 at the beginning of the period. In this case, the shape of a portfolio indicative of the investment needs is the same as that of the portfolio 200 shown in FIG. 34(A).

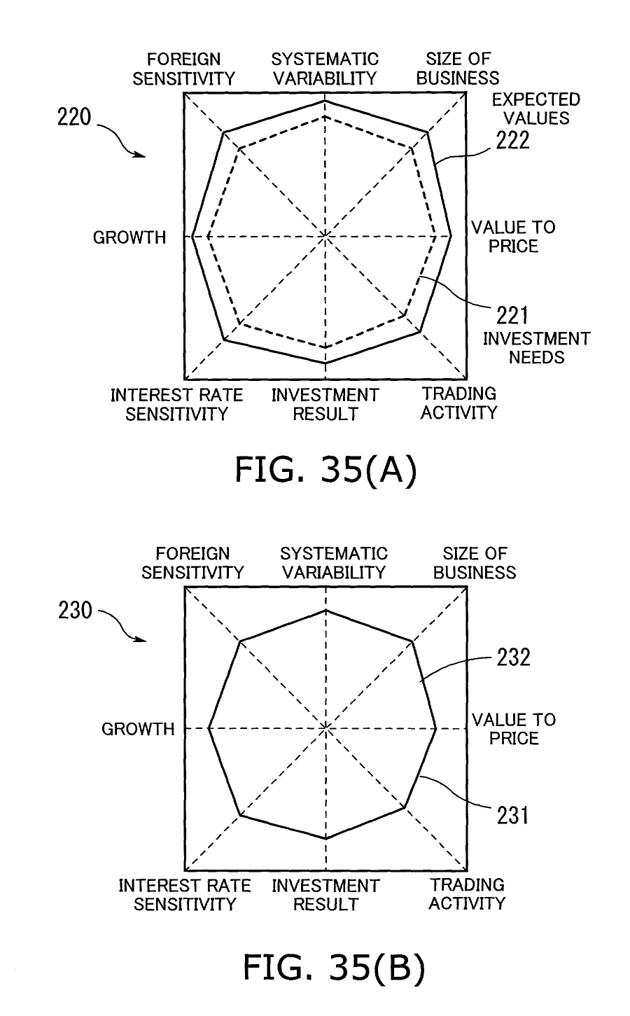

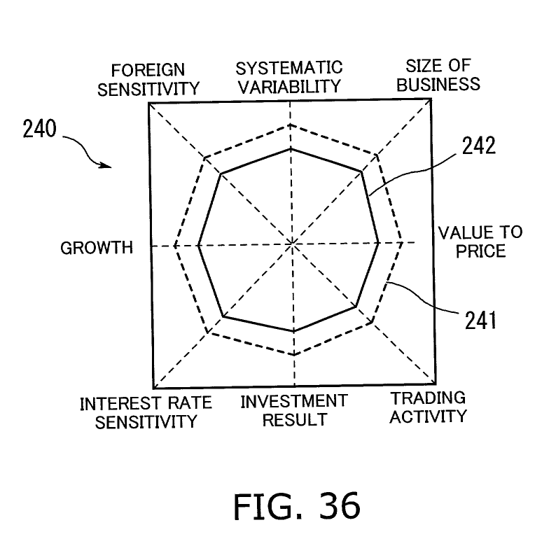

FIGS. 35(A), 35(B) and 36 are views showing portfolios 220, 230, and 240, respectively, of investment needs fulfillment financial assets selected as financial assets which fulfill these investment needs and indicated in information stored in the investment needs fulfillment financial assets information storing section 44.

As shown in FIG. 35(A), the shape of a radar chart indicative of expected values 222 of the investment needs fulfillment financial assets shown in the portfolios 220 is almost similar to that of a radar chart indicative of investment needs 221. The same applies to FIGS. 35(B) and 36. Especially in FIG. 35(B), the shape and size of the radar chart indicative of investment needs 231 is just the same as those of the radar chart indicative of expected values 232 of the investment needs fulfillment financial assets.

As stated above, in the process of step S7, the degrees of similarity in shape and size between the radar charts indicative of the expected values 222 of the investment needs fulfillment financial assets and the investment needs 221, between the radar charts indicative of the expected values 232 of the investment needs fulfillment financial assets and the investment needs 231, and the radar charts indicative of the expected values 242 of the investment needs fulfillment financial assets and the investment needs 241 are checked. In this case, the degree of similarity in shape and size between the radar charts indicative of the expected values 232 of the investment needs fulfillment financial assets and the investment needs 231 is the highest, so the rebalanced financial assets with the expected values 232 (rebalanced financial assets indicated by the portfolio 230) will be extracted as optimum rebalanced financial assets.

Now, the details of the process performed in step S8 in the flow chart shown in FIG. 23 will be described.

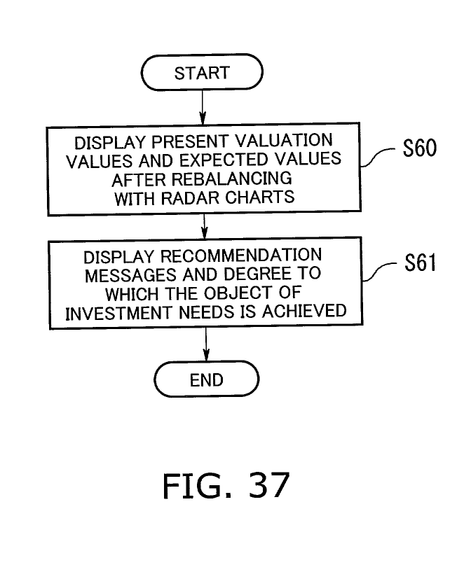

FIG. 37 is a flow chart for describing the details of the process performed in step S8 in the flow chart shown in FIG. 23. The details of the process performed in step S8 in the flow chart shown in FIG. 23 will now be described in compliance with this flow chart.

[Step S60] In this step, the rebalanced financial assets information displaying section 56 displays the present valuation values of the held financial assets and the expected values after rebalancing (expected values of the optimum rebalanced financial assets) extracted by the process in step S7 in the flow chart shown in FIG. 23 with a radar chart.

For example, the rebalanced financial assets information displaying section 56 obtains information regarding the optimum rebalanced financial assets from the optimum rebalanced financial assets extracting section 55, obtains information regarding the held financial assets from the securities information storing section 41 and held financial asset structure information storing section 42, and obtains information regarding the measures of valuation from the valuation measure selecting section 46. The rebalanced financial assets information displaying section 56 displays a radar chart indicative of the present valuation values of the held financial assets which is drawn up by the use of the obtained information and a radar chart indicative of the expected values of the optimum rebalanced financial assets extracted by the process in step S7.

[Step S61] In this step, the rebalanced financial assets information displaying section 56 displays recommendation messages and the degree to which the object of the investment needs is achieved.

For example, the rebalanced financial assets information displaying section 56 extracts a recommendation message corresponding to a condition suitable to the expected values of the optimum rebalanced financial assets extracted by the process in step S7 from the recommendation message information storing section 43 and displays it. In addition, the rebalanced financial assets information displaying section 56 displays the degree to which the object of the investment needs is achieved calculated from the difference between the expected values of the optimum rebalanced financial assets extracted by the process in step S7 and expected values indicative of the investment needs.

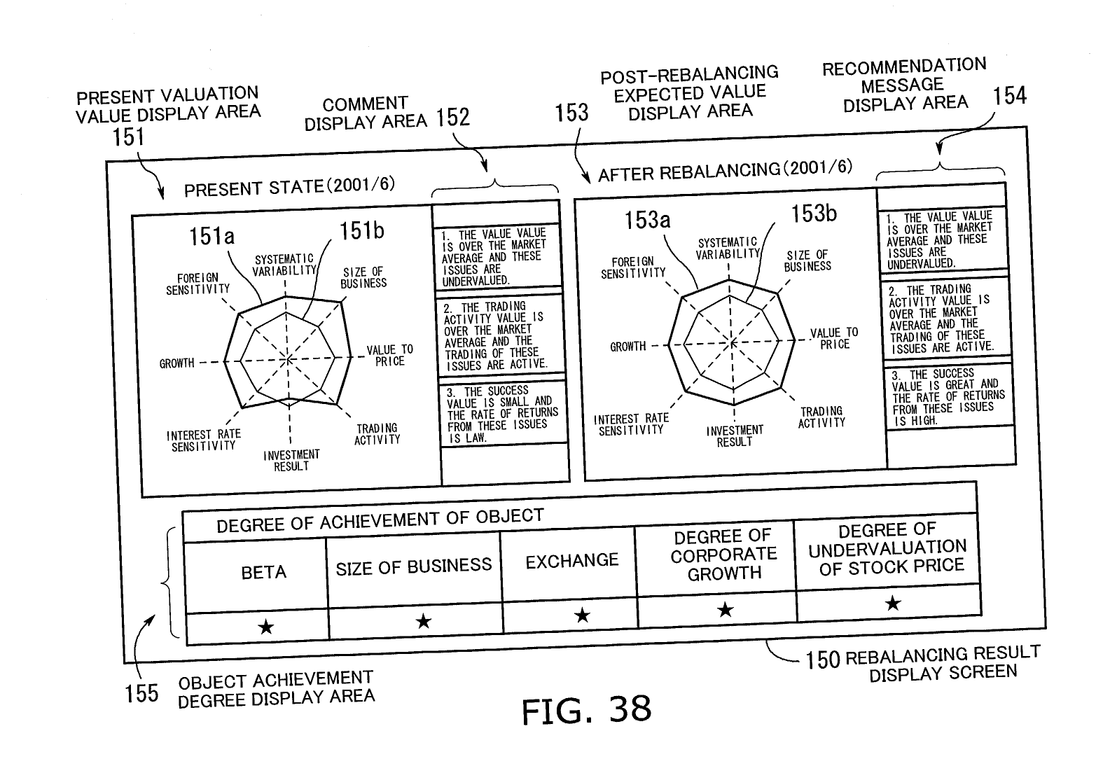

FIG. 38 is a view showing a rebalancing result display screen 150 including the radar chart indicative of the present valuation values of the held financial assets which is displayed by the process in step S60, the radar chart indicative of the expected values of the optimum rebalanced financial assets extracted by the process in step S7 which is displayed by the process in step S60, and the recommendation message and the degree to which the object of the investment needs is achieved which are displayed by the process in step S61.

As shown in FIG. 38, the rebalancing result display screen 150 consists of, for example, a present valuation value display area 151 where a radar chart indicative of the present valuation values of held financial assets is displayed, a comment display area 152 where comments indicative of the contents of the valuation of the held financial assets are displayed, a post-rebalancing expected value display area 153 where a radar chart indicative of the expected values of optimum rebalanced financial assets extracted by the process in step S7 is displayed, a recommendation message display area 154 where recommendation messages regarding the optimum rebalanced financial assets are displayed, and an object achievement degree display area 155 where the degree to which the object of investment needs is achieved is displayed.

In this example, in the present valuation value display area 151, the radar chart indicative of the present valuation values of held financial assets which consists of eight measures of valuation, being Systematic Variability, Size of Business, Value to Price, Trading Activity, Investment Result, Interest Rate Sensitivity, Growth, and Foreign Sensitivity, is displayed. On this radar chart, a line 151a which indicates the present valuation values of the held financial assets and a line 151b which indicates a market average corresponding to each measure of valuation are displayed.

In the post-rebalancing expected value display area 153, the radar chart indicative of the expected values of optimum rebalanced financial assets which consists of eight measures of valuation, being Systematic Variability, Size of Business, Value to Price, Trading Activity, Investment Result, Interest Rate Sensitivity, Growth, and Foreign Sensitivity, is displayed. On this radar chart, a line 153a which indicates the expected values of the optimum rebalanced financial assets and a line 153b which indicates a market average corresponding to each measure of valuation are displayed.

In the comment display area 152, the comments “1. Value of Value to Price is over the market average and these issues are undervalued.”, “2. Value of Trading Activity is over the market average and the trading of these issues are active.”, and “3. Value of Investment Result is small and the rate of returns from these issues is low.” are displayed. In the recommendation message display area 154, the messages “1. Value of Value to Price is over the market average and these issues are undervalued.”, “2. Value of Trading Activity is over the market average and the trading of these issues are active.”, and “3. Value of Investment Result is great and the rate of returns from these issues is high.” are displayed. In the object achievement degree display area 155, the degree to which the object of investment needs is achieved by the optimum rebalanced financial assets is indicated by “★.”

By looking at the rebalancing result display screen 150, an investor can recognize visually and intuitively how the expected values of his/her financial assets are improved by rebalancing his/her financial assets. In addition, he/she can see in detail the contents of the degree of the improvement by messages displayed in the recommendation message display area 154.

The details of the contents of held financial assets can be displayed by the method of clicking in the present valuation value display area 151 on the rebalancing result display screen 150 or the details of the optimum rebalanced financial assets can be displayed by the method of clicking in the post-rebalancing expected value display area 153.

As described above, in the second embodiment, the investment needs information inputting section 51 accepts input investment needs information, being information indicative of an investor's investment needs about his/her financial assets, the financial asset structure rebalancing section 52 changes at least part of held financial assets indicated in held financial asset structure information stored in the held financial asset structure information storing section 42 to other securities, the rebalanced financial asset expected value calculating section 53 calculates the expected values by a plurality of measures of valuation of rebalanced financial assets, being the held financial assets at least part of which were changed to other securities by the financial asset structure rebalancing section 52, by the use of securities attribute information stored in the securities information storing section 41, the investment needs fulfillment judging section 54 judges whether the expected values of the rebalanced financial assets calculated by the rebalanced financial asset expected value calculating section 53 correspond to investment needs indicated in the investment needs information input by the investment needs information inputting section 51, and the rebalanced financial assets information displaying section 56 visually displays the expected values of rebalanced financial assets judged by the investment needs fulfillment judging section 54 to be correspondent to the investment needs with a radar chart. A user of the asset management invitation unit 40 therefore can visually display information regarding the most suitable financial asset management to investment needs with a radar chart indicative of expected values by a plurality of measures of valuation only by inputting the investment needs to the asset management invitation unit 40. As a result, a person without advanced expertise can smoothly conduct the business of inviting an investor to manage his/her financial assets.

Especially with a method for inviting asset management by the use of the asset management invitation unit 40, financial asset management which fulfills investment needs will be recommended on the basis of expected values by a plurality of measures of valuation, so carefully thought-out investment strategies and rebalancing strategies which fulfill investors' various investment needs can be suggested.

In addition, this suggestion will be given by displaying visually expected values corresponding to recommended financial asset management with a radar chart, so investors can intuitively recognize the contents of carefully thought-out financial asset management suggested according to their various investment needs. As a result, the business of inviting an investor to manage his/her financial assets can be conducted smoothly.

The rebalanced financial asset expected value calculating section 53 calculates the expected values of rebalanced financial assets by measures of valuation selected by the valuation measure selecting section 46. As a result, the rebalanced financial assets information displaying section 56 can display a radar chart indicative of expected values by measures of valuation most suitable to an investment climate. This also makes the business of inviting an investor to manage his/her financial assets smoother.

The optimum rebalanced financial assets extracting section 55 compares a first radar chart indicative of an investor's investment needs indicated in investment needs information input by the investment needs information inputting section 51 and each of second radar charts indicative of the expected values of rebalanced financial assets calculated by the rebalanced financial asset expected value calculating section 53 and select a second radar chart with the highest degree of similarity in shape and size to the first radar chart of second radar charts almost similar to the first radar chart. The optimum rebalanced financial assets extracting section 55 extracts rebalanced financial assets having the expected values indicated in that radar chart as optimum rebalanced financial assets. Moreover, the rebalanced financial assets information displaying section 56 visually displays the expected values of the optimum rebalanced financial assets extracted by the optimum rebalanced financial assets extracting section 55 with the second radar chart. As a result, anyone can easily give a suggestion regarding the most suitable financial asset management to investment needs. This also makes the business of inviting an investor to manage his/her financial assets smoother.

The rebalanced financial assets information displaying section 56 displays recommendation messages about rebalanced financial assets the expected values of which were judged by the investment needs fulfillment judging section 54 to be correspondent to investment needs. As a result, detailed information regarding the rebalanced financial assets can be given to an investor. This also makes the business of inviting an investor to manage his/her financial assets smoother.

The rebalanced financial assets information displaying section 56 displays the degree of the achievement of an object indicative of the degree to which the object of investment needs is achieved by rebalanced financial assets the expected values of which were judged by the investment needs fulfillment judging section 54 to be correspondent to the investment needs. As a result, an investor can intuitively recognize the degree to which his/her investment needs are fulfilled by the rebalanced financial assets. This also makes the business of inviting an investor to manage his/her financial assets smoother.

The securities attribute information updating section 48 updates securities attribute information stored in the securities information storing section 41. As a result, rebalanced financial assets can be suggested to an investor with the latest running of the market taken into consideration. This also makes the business of inviting an investor to manage his/her financial assets smoother.

Investment needs information input by the investment needs information inputting section 51 is generated on the basis of information input by an investor in the form of an answer to a questionnaire. As a result, anyone can easily set appropriate investment needs. This also makes the business of inviting an investor to manage his/her financial assets smoother.

The rebalanced financial assets information displaying section 56 displays a second radar chart indicative of the expected values of rebalanced financial assets calculated by the rebalanced financial asset expected value calculating section 53 and a third radar chart indicative of the present valuation values of held financial assets indicated in held financial asset structure information for the sake of contrast. As a result, an investor can recognize visually and intuitively how the expected values of his/her financial assets are improved by rebalancing his/her financial assets. This also makes the business of inviting an investor to manage his/her financial assets smoother.

The present invention is not limited to the above embodiment. In this embodiment, securities used for rebalancing financial assets are narrowed down by the process in step S3 in the flow chart shown in FIG. 23 and the financial asset structure rebalancing section 52 rebalances the structure of the financial assets by the use of the narrowed down securities. Instead of performing the process in step S3, however, the financial asset structure rebalancing section 52 may rebalance the structure of financial assets by the use of all of the securities indicated in information stored in the securities information storing section 41.

As stated above, the above processes can be performed with a computer. In that case, a program in which the contents of the functions the securities selection support unit 10 or the asset management invitation unit 4 or 40 should have are described is provided. The above functions can be realized on a computer by executing this program on the computer. This program can be recorded on a computer-readable record medium. A computer-readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disc (DVD), a digital versatile disc random access memory (DVD-RAM), a compact disc read only memory (CD-ROM), a compact disc recordable (CD-R)/rewritable (CD-RW), or the like. A magneto-optical recording medium can be a magneto-optical disc (MO) or the like.

To place this program on the market, portable record media, such as DVDs or CD-ROMs, on which it is recorded are sold. Alternatively, this program can be stored in a memory in a server computer and be transferred from the server computer to another computer via a network.

When a computer executes this program, it will store the program, which is recorded on a portable record medium or is transferred from the server computer, on, for example, its hard disk. Then it reads the program from its hard disk and performs processes in compliance with the program. The computer can also read the program directly from a portable record medium and perform processes in compliance with the program. In addition, the computer can perform processes in compliance with the program transferred in order from the server computer.

As has been described in the foregoing, in the present invention, when proposed investment securities are selected, the deviations of investment risks on the proposed investment securities selected from investment risk standard values are calculated according to risk indexes and messages corresponding to the deviations according to the risk indexes are output. A person without expertise in asset management therefore can easily find the characteristics of investment risks on proposed investment securities.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A securities selection support method for supporting the selection of a target for investment with a computer, the method comprising the steps of:
selecting proposed investment securities to be invested in from among a plurality of securities;
calculating investment risk standard values according to a plurality of risk indexes on the basis of investment risk information in which an investment risk regarding the plurality of risk indexes is set for each of the plurality of securities;
calculating deviations according to the plurality of risk indexes by comparing the investment risk standard values according to the plurality of risk indexes and a risk on an investment in the proposed investment securities set in the investment risk information; and
outputting messages indicative of characteristics of the risk on the investment in the proposed investment securities in accordance with the calculated deviations according to the plurality of risk indexes.

2. The securities selection support method according to claim 1, further comprising the step of drawing and outputting a comparative diagram indicative of results of comparisons according to the plurality of risk indexes between the investment risk standard value and the risk on the investment.

3. The securities selection support method according to claim 2, wherein a radar chart with each of the plurality of risk indexes as an axis is drawn up as the comparative diagram.

4. A securities selection support method for supporting the selection of a target for investment with a computer, the method comprising the steps of:
selecting a combination of a plurality of proposed investment securities to be invested in from among a plurality of securities;
calculating investment risk standard values according to a plurality of risk indexes on the basis of investment risk information in which an investment risk regarding the plurality of risk indexes is set for each of the plurality of securities;
calculating compound investment risks according to the plurality of risk indexes in the case of investing in a combination of the selected proposed investment securities on the basis of the investment risk information;
calculating deviations according to the plurality of risk indexes by comparing the investment risk standard values and the compound investment risks according to the plurality of risk indexes; and
outputting messages indicative of characteristics of the compound investment risks in accordance with the calculated deviations according to the plurality of risk indexes.

5. A securities selection support method for supporting the selection of a target for investment with a computer, the method comprising the steps of:
selecting a base issue group from among a plurality of issue groups each of which has been set as a set of pieces of identification information for a plurality of securities;
selecting proposed investment securities to be invested in from among the plurality of securities;
obtaining investment risks on securities corresponding to the pieces of identification information included in the base issue group selected from investment risk information in which investment risks regarding a plurality of risk indexes are set for each of the plurality of securities and calculating investment risk standard values according to the plurality of risk indexes on the basis of the investment risks;
calculating deviations according to the plurality of risk indexes by comparing, according to the plurality of risk indexes, the investment risk standard values and an investment risk on the proposed investment securities set in the investment risk information; and
outputting messages indicative of characteristics of the investment risk on the proposed investment securities in accordance with the calculated deviations according to the plurality of risk indexes.

6. An asset management invitation method for recommending managing financial assets including a plurality of securities with a computer, in the case of securities attribute information, being information indicative of attributes of the securities included in the financial assets, and held financial asset structure information, being information indicative of structure of held financial assets being the financial assets held by an investor, having been stored in a recorder, the method comprising the steps of:
accepting input of investment needs information, being information indicative of the investor's investment needs about the financial assets;
changing at least part of the held financial assets indicated in the held financial asset structure information stored in the recorder to other securities;
calculating expected values by a plurality of measures of valuation of rebalanced financial assets, being the held financial assets at least part of which were changed to the other securities, by the use of the securities attribute information stored in the recorder;
judging whether the calculated expected values of the rebalanced financial assets correspond to the investment needs indicated in the input investment needs information; and
displaying visually the expected values of the rebalanced financial assets judged to be correspondent to the investment needs with a graph.

7. A securities selection support program for supporting the selection of a target for investment that causes a computer to perform the steps of:
selecting proposed investment securities from among a plurality of securities;
calculating investment risk standard values according to a plurality of risk indexes on the basis of investment risk information in which an investment risk regarding the plurality of risk indexes is set for each of the plurality of securities;
calculating deviations according to the plurality of risk indexes by comparing the investment risk standard values according to the plurality of risk indexes and a risk on an investment in the proposed investment securities set in the investment risk information; and
outputting messages indicative of characteristics of the risk on the investment in the proposed investment securities in accordance with the calculated deviations according to the plurality of risk indexes.

8. A securities selection support program for supporting the selection of a target for investment that causes a computer to perform the steps of:
selecting a combination of a plurality of proposed investment securities to be invested in from among a plurality of securities;
calculating investment risk standard values according to a plurality of risk indexes on the basis of investment risk information in which an investment risk regarding the plurality of risk indexes is set for each of the plurality of securities;
calculating compound investment risks according to the plurality of risk indexes in the case of investing in a combination of the selected proposed investment securities on the basis of the investment risk information;
calculating deviations according to the plurality of risk indexes by comparing the investment risk standard values and the compound investment risks according to the plurality of risk indexes; and
outputting messages indicative of characteristics of the compound investment risks in accordance with the calculated deviations according to the plurality of risk indexes.

9. A securities selection support program for supporting the selection of a target for investment, the program causing a computer to perform the steps of:
selecting a base issue group from among a plurality of issue groups each of which has been set as a set of pieces of identification information for a plurality of securities;
selecting proposed investment securities to be invested in from among the plurality of securities;
obtaining investment risks on securities corresponding to the pieces of identification information included in the base issue group selected from investment risk information in which investment risks regarding a plurality of risk indexes are set for each of the plurality of securities and calculating investment risk standard values according to the plurality of risk indexes on the basis of the investment risks;
calculating deviations according to the plurality of risk indexes by comparing, according to the plurality of risk indexes, the investment risk standard values and an investment risk on the proposed investment securities set in the investment risk information; and
outputting messages indicative of characteristics of the investment risk on the proposed investment securities in accordance with the calculated deviations according to the plurality of risk indexes.

10. An asset management invitation program for recommending managing financial assets including a plurality of securities, in the case of securities attribute information, being information indicative of attributes of the securities included in the financial assets, and held financial asset structure information, being information indicative of structure of held financial assets being the financial assets held by an investor, having been stored in a recorder, the program causing a computer to perform the steps of:
accepting input of investment needs information, being information indicative of the investor's investment needs about the financial assets;
changing at least part of the held financial assets indicated in the held financial asset structure information stored in the recorder to other securities;
calculating expected values by a plurality of measures of valuation of rebalanced financial assets, being the held financial assets at least part of which were changed to the other securities, by the use of the securities attribute information stored in the recorder;
judging whether the calculated expected values of the rebalanced financial assets correspond to the investment needs indicated in the input investment needs information; and
displaying visually the expected values of the rebalanced financial assets judged to be correspondent to the investment needs with a graph.

11. A securities selection support unit for supporting the selection of a target for investment, the unit comprising:
a storing section for storing investment risk information in which investment risks regarding a plurality of risk indexes have been set according to a plurality of securities;
a selecting section for selecting proposed investment securities to be invested in from among the plurality of securities;
an investment risk standard value calculating section for calculating investment risk standard values according to the plurality of risk indexes on the basis of the investment risk information stored in the storing section;
a deviation calculating section for calculating deviations according to the plurality of risk indexes by comparing the investment risk standard values according to the plurality of risk indexes calculated by the investment risk standard value calculating section and investment risks on the proposed investment securities set in the investment risk information stored in the storing section; and
an outputting section for outputting messages indicative of the characteristics of the investment risks on the proposed investment securities in accordance with the deviations according to the plurality of risk indexes calculated by the deviation calculating section.

12. A securities selection support unit for supporting the selection of a target for investment, the unit comprising:
a storing section for storing investment risk information in which investment risks regarding a plurality of risk indexes have been set according to a plurality of securities;
a selecting section for selecting a combination of a plurality of proposed investment securities to be invested in from among the plurality of securities;
an investment risk standard value calculating section for calculating investment risk standard values according to the plurality of risk indexes on the basis of the investment risk information stored in the storing section;
a compound investment risk calculating section for calculating compound investment risks according to the plurality of risk indexes in the case of investing in the combination of the proposed investment securities selected by the selecting section on the basis of the investment risk information stored in the storing section;
a deviation calculating section for calculating deviations according to the plurality of risk indexes by comparing the investment risk standard values according to the plurality of risk indexes calculated by the investment risk standard value calculating section and the compound investment risks calculated by the compound investment risk calculating section; and
an outputting section for outputting messages indicative of characteristics of the compound investment risks in accordance with the deviations according to the plurality of risk indexes calculated by the deviation calculating section.

13. A securities selection support unit for supporting the selection of a target for investment, the unit comprising:
an issue group storing section for storing a plurality of issue groups, each being a set of pieces of identification information for a plurality of securities;
an investment risk information storing section for storing investment risk information in which investment risks regarding a plurality of risk indexes have been set according to the securities;
a base issue group selecting section for selecting a base issue group from among the plurality of issue groups stored in the issue group storing section;
a proposed investment securities selecting section for selecting proposed investment securities to be invested in from among the plurality of securities;
an investment risk standard value calculating section for obtaining investment risks on securities corresponding to the pieces of identification information included in the base issue group selected by the base issue group selecting section from the investment risk information stored in the investment risk information storing section and for calculating investment risk standard values according to the plurality of risk indexes on the basis of the investment risks;
a deviation calculating section for calculating deviations according to the plurality of risk indexes by comparing the investment risk standard values according to the plurality of risk indexes calculated by the investment risk standard value calculating section and investment risks on the proposed investment securities set in the investment risk information; and
an outputting section for outputting messages indicative of characteristics of the investment risks on the proposed investment securities in accordance with the deviations according to the plurality of risk indexes calculated by the deviation calculating section.

14. An asset management invitation unit for recommending managing financial assets including a plurality of securities, the unit comprising:
a securities information storing section for storing securities attribute information, being information indicative of attributes of the securities included in the financial assets;
a held financial asset structure information storing section for storing held financial asset structure information, being information indicative of structure of held financial assets being the financial assets held by an investor;
an investment needs information inputting section for accepting input of investment needs information, being information indicative of the investor's investment needs about the financial assets;
a financial asset structure rebalancing section for changing at least part of the held financial assets indicated in the held financial asset structure information stored in the held financial asset structure information storing section to other securities;
a rebalanced financial assets expected value calculating section for calculating expected values by a plurality of measures of valuation of rebalanced financial assets, being the held financial assets at least part of which were changed to the other securities by the financial asset structure rebalancing section, by the use of the securities attribute information stored in the securities information storing section;
an investment needs fulfillment judging section for judging whether the calculated expected values of the rebalanced financial assets calculated by the rebalanced financial assets expected value calculating section correspond to the investment needs indicated in the investment needs information input by the investment needs information inputting section; and
a rebalanced financial assets information display section for displaying visually the expected values of the rebalanced financial assets judged by the investment needs fulfillment judging section to be correspondent to the investment needs with a graph.

15. A computer-readable record medium that stores a securities selection support program for supporting the selection of a target for investment, the program causing a computer to perform the steps of:
selecting proposed investment securities from among a plurality of securities;
calculating investment risk standard values according to a plurality of risk indexes on the basis of investment risk information in which an investment risk regarding the plurality of risk indexes is set for each of the plurality of securities;
calculating deviations according to the plurality of risk indexes by comparing the investment risk standard values according to the plurality of risk indexes and a risk on an investment in the proposed investment securities set in the investment risk information; and
outputting messages indicative of characteristics of the risk on the investment in the proposed investment securities in accordance with the calculated deviations according to the plurality of risk indexes.

16. A computer-readable record medium that stores a securities selection support program for supporting the selection of a target for investment, the program causing a computer to perform the steps of:
selecting a combination of a plurality of proposed investment securities to be invested in from among a plurality of securities;
calculating investment risk standard values according to a plurality of risk indexes on the basis of investment risk information in which an investment risk regarding the plurality of risk indexes is set for each of the plurality of securities;
calculating compound investment risks according to the plurality of risk indexes in the case of investing in a combination of the selected proposed investment securities selected entails on the basis of the investment risk information;
calculating deviations according to the plurality of risk indexes by comparing the investment risk standard values and the compound investment risks according to the plurality of risk indexes; and
outputting messages indicative of characteristics of the compound investment risks in accordance with the calculated deviations according to the plurality of risk indexes.

17. A computer-readable record medium that stores a securities selection support program for supporting the selection of a target for investment, the program causing a computer to perform the steps of:
selecting a base issue group from among a plurality of issue groups each of which has been set as a set of pieces of identification information for a plurality of securities;
selecting proposed investment securities to be invested in from among the plurality of securities;
obtaining investment risks on securities corresponding to the pieces of identification information included in the base issue group selected from investment risk information in which investment risks regarding a plurality of risk indexes are set for each of the plurality of securities and calculating investment risk standard values according to the plurality of risk indexes on the basis of the investment risks;
calculating deviations according to the plurality of risk indexes by comparing, according to the plurality of risk indexes, the investment risk standard values and an investment risk on the proposed investment securities set in the investment risk information; and
outputting messages indicative of characteristics of the investment risk on the proposed investment securities in accordance with the calculated deviations according to the plurality of risk indexes.

18. A computer-readable record medium that stores an asset management invitation program for recommending managing financial assets including a plurality of securities, in the case of securities attribute information, being information indicative of attributes of the securities included in the financial assets, and held financial asset structure information, being information indicative of structure of held financial assets being the financial assets held by an investor, having been stored in a recorder, the program causing a computer to perform the steps of:
accepting input of investment needs information, being information indicative of the investor's investment needs about the financial assets;
changing at least part of the held financial assets indicated in the held financial asset structure information stored in the recorder to other securities;
calculating expected values by a plurality of measures of valuation of rebalanced financial assets, being the held financial assets at least part of which were changed to the other securities, by the use of the securities attribute information stored in the recorder;
judging whether the calculated expected values of the rebalanced financial assets correspond to the investment needs indicated in the input investment needs information; and
displaying visually the expected values of the rebalanced financial assets judged to be correspondent to the investment needs with a graph.
